(19) United States
(12) Patent Application Publication
(10) Pub. No.: US 2003/0036947 A1
(43) Pub. Date: Feb. 20, 2003

(54) Systems and methods for submission, development and evaluation of ideas in an organization

(75) Inventors: William E. Smith III, Suwanee, GA (US); Nancy E. Halpern, Duluth, GA (US)

Correspondence Address: PAUL W. MARTIN, LAW DEPARTMENT, WHQ-5E, 1700 S. PATTERSON BLVD., DAYTON, OH, 45479-0001, US

(73) Assignee: NCR Corporation

(21) Appl. No.: 09/933,285

(22) Filed: Aug. 20, 2001

(51) Int. Cl. G06F 17/60

(52) U.S. Cl. 705/10; 705/1; 705/9

(57) ABSTRACT

Systems and techniques are described for managing the submission of ideas in an organization. According to one technique, ideas are collected and entered into an electronic archive accessible through a network. This is followed by displaying the ideas to members of the organization so that the members of the organization can provide additional thoughts related to the submission. The ideas are then provided to a management screening committee for screening. The screened ideas are then submitted to an idea sponsor. This is followed by an opportunity screening phase, in which the submitted, screen ideas are further developed and evaluated. A further aspect of the described systems and techniques provides an idea submission tool for submission of ideas using a web-based interface.

### BACKGROUND OF THE INVENTION

1. Field of the Invention

The present invention relates generally to systems and methods for the management of ideas in an organization, and more particularly to advantageous aspects of network-based systems and methods for the submission, development, and evaluation of ideas in an organization.

2. Description of the Prior Art

Ideas can be an extremely valuable asset to a business or other type of organization. However, a business organization typically does not have a consistent and timely mechanism to encourage, capture and coordinate potentially valuable ideas from multiple sources available to the organization such that the ideas are accessible from a consistent source within the organization. Ideas are currently submitted at all levels in an organization through multiple informal channels, requiring considerable manual intervention to complete the submission of the idea. In addition, the visibility of the submitted ideas is often restricted to the submitter's immediate work group. Because of this restricted access to submitted ideas, there is no opportunity for others outside the submitting team to provide supporting information or insight that could enhance the original idea or evaluate alternative applications of the idea. Many potentially valuable ideas are lost, due to lack of time, interest, or budget available to the manager to whom the idea was submitted. Also, there is often no means of resurrecting an idea that has been postponed for business reasons.

Today's marketplace requires a business to be flexible to keep pace with agile competitors. However, the lack of development alternatives resulting from haphazard idea submissions makes effective portfolio management and planning difficult. There is thus a need for systems and methods for coordinated idea submission, development, and evaluation.

### SUMMARY OF THE INVENTION

The above-described issues and others are addressed by the present invention, aspects of which are directed to systems and methods for managing the submission of ideas in an organization. One method according to the invention comprises collecting ideas and entering the collected ideas into an electronic archive accessible through a network. This is followed by displaying the ideas to members of the organization so that the members of the organization can provide additional thoughts related to the merit, business potential, and priority of an idea that is submitted for review. The ideas are then provided to a management screening committee for screening, based on parameters such as portfolio fit, urgency to the business, technical feasibility and risks. The screened ideas are then submitted to an idea sponsor, who has the authority to assign resources to “flesh out” the idea further. The method then enters an opportunity screening phase for further development and evaluation, based on the idea sponsor's approval and recommendations. A further aspect of the invention includes an idea submission tool for submission of ideas using a web-based interface, providing a consistent access to the system, thereby facilitating easier access to the to the tools and process, and thus promoting the use of these tools.

Additional features and advantages of the present invention will become apparent by reference to the following detailed description and accompanying drawings.

### BRIEF DESCRIPTION OF THE DRAWINGS

FIG. 1 shows a diagram of an idea submission system according to a first aspect of the present invention.

FIG. 2 shows a graphical model in which a marketplace is mapped again a business enterprise's solution technology and service capabilities

FIG. 3 shows a diagram of an exemplary Global Realization Process that incorporates an embodiment of the invention.

FIG. 4 shows a “target” model 80 for conceptualizing an embodiment of the invention.

FIG. 5 shows a flowchart of an embodiment of a method according to the invention.

FIG. 6 shows a flowchart of the Idea Generation Phase of an idea submission system according to the present invention.

FIGS. 7-11 show tables listing the respective inputs, tasks and outputs for various steps of the Idea Generation Phase illustrated in the FIG. 6 flowchart.

FIG. 12 shows a checklist for use in the Idea Generation Phase illustrated in the FIG. 6 flowchart.

FIG. 13 shows a screenshot of an Idea Submission Tool according to a further aspect of the present invention.

FIG. 14 shows a flowchart of the Opportunity Screening Phase of an idea submission system according to the present invention.

FIGS. 15-21 show tables listing the respective inputs, tasks and outputs for various steps of the Opportunity Screening Phase illustrated in the FIG. 11 flowchart.

FIG. 22 shows a checklist for use in the Opportunity Screening Phase illustrated in the FIG. 14 flowchart.

FIG. 23 shows a risk model illustrating the balancing of risk and return in conjunction with an idea submission system according to the present invention.

FIG. 24 shows a graph illustrating the startup period of an embodiment of the present invention.

FIG. 25 is a diagram illustrating a staffing structure according to a further aspect of the present invention.

FIG. 26 is a diagram illustrating the workload of a Concept Team in accordance with a further aspect of the invention.

### DETAILED DESCRIPTION

According to a first aspect of the present invention, an integrated database provides a central avenue for idea submission and for the viewing of all submitted ideas. It provides the opportunity for employees, potential development partners, and customers to contribute ideas and to enhance ideas submitted by others. The integrated database provides visibility and simultaneous access to all submitted ideas to a broad number of business, engineering, sales and service representatives, as well as marketing managers, who will have the opportunity to evaluate, prioritize, and “vote” on the submitted ideas. The invention enables decision-makers to evaluate ideas on the basis of innovation, potential for competitive advantage, and alignment with the organization's core competencies and strategy. The invention further serves as a central repository accessible by other business units to review the potential for leveraging ideas submitted from other organizations.

As described in further detail below, a first embodiment of the Idea Shop includes two main components: idea generation and opportunity screening. The following definitions are used herein:

An “idea” is any input submitted to the Idea Shop system that demonstrates potential for generating revenue, reducing costs or enhancing the competitiveness of a product portfolio.

A “concept” is an output of the Idea Shop system. Thus, as used herein, a “concept” is different from an “idea.” An “idea” is an element of a “concept.” A completed “concept” is supported by initial business potential and feasibility assessments being completed.

A “solution” is an offering by the business enterprise, which may include hardware, software, or services, or a combination thereof.

“Portfolio management” is the continual review of the assessment of the strategic fit, competitiveness, and profitability potential of a “product family” offered by a business. Portfolio management is usually a strategic leadership team function that may or may not be performed by a business unit resource board, depending upon the organization of the business unit.

Ideas generated by this process are developed, cultivated, and supported by the Idea Shop concept team. Idea generation activities include: championing the use of the Idea Shop and promoting the advantages of the tool; encouraging and supporting the collection of ideas from multiple sources within and outside the business unit; combining input from various sources to generate new ideas within the concept team; evaluating ideas for strategic fit, competitive advantage and leverage opportunities, and choosing the best ideas to be developed into concepts for presentation to a resource board/portfolio manager; and maintaining an up-to-date searchable idea/concept archive accessible to all business units through a knowledge management system.

Opportunity screening activities include: developing ideas into concept evaluation review presentations through use of direct access secondary market/competitive research; rating and ranking ideas in alignment with strategic goals, portfolio fit, the business enterprise's core capabilities, corporate risk model, and market window issues; regularly elevating the best concepts to resource board/portfolio manager for evaluation against the existing portfolio; and championing and driving the strongest concepts presenting highest return potential.

The Idea Shop is driven by a dedicated concept team, which is committed to activities supporting and nurturing creativity and idea generation through communication programs focused on all functional areas throughout a business unit. The concept team is also responsible for developing collected ideas into presentable solution concepts that can be assessed with regard to portfolio needs, competitive differentiation, and then funded for development by the business unit.

The number of full-time (core) and consulting (subject-matter expert) members of a concept team is determined by each business unit, depending on individual goals, and on the resources available to support the Idea Shop process. However, the process depends on consistent and on-going management and activity. Similar past initiatives have failed due to the lack of consistent follow-through by part-time or ad hoc approaches. Without at least one full-time dedicated team leader, the Idea Shop may lose effectiveness when part-time resources are inevitably diverted to meet short-term needs. Therefore, the Idea Shop should be considered a long-term investment, in which each business unit pursues the goal of justifying and supporting a well-qualified, well-trained dedicated core team. Regardless of team size, the skill set of the concept team should be optimized to cover the major Idea Shop skill requirements described below.

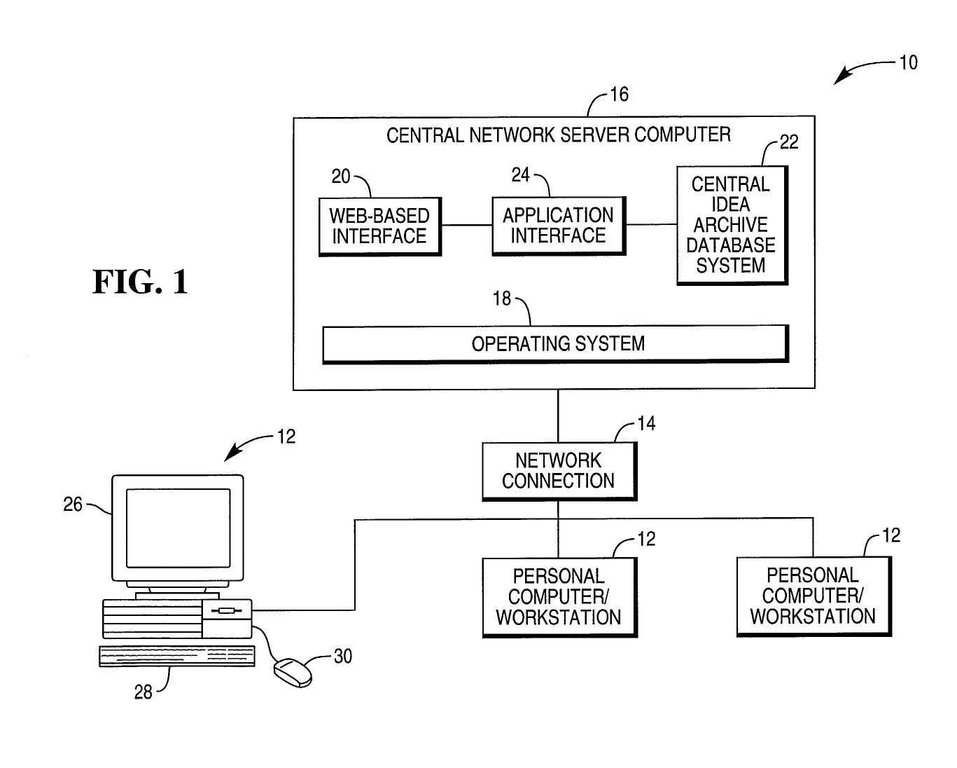

FIG. 1 shows a diagram of a first aspect of a system 10 according to the present invention. System 10 includes a network of personal computers or workstations 12 that are provided with a network connection 14 to a central network server computer 16. As shown in FIG. 1, the central server computer 16 runs on a suitable operating system platform 18, such as Windows 98, 2000, or NT. The central server computer 16 runs a web-based interface that communicates with a central idea archive database system 22 through a suitable application interface. The central archive database system 22 may be implemented using Lotus Notes or other suitable database software (such as ACCESS, or the like). As further shown in FIG. 1, the personal computers or workstations 12 connected into the network include a display screen 26 and suitable input devices, including a keyboard 28 and a mouse 30. It should be noted that although the network interface 20 is web-based, the present invention may be practiced both over the Internet, as well as over an intra-organizational network.

In addition to the components of the system 10 illustrated in FIG. 1, the present invention further includes a detailed process that supports the use and management of the idea submission system. This process is described in detail below. The features of the overall system, herein referred to as the “Idea Shop,” may advantageously include the following:

1. A web-based interface.

2. An easy-to-use idea capture screen.

3. The ability to display and search ideas by tracking number (more recent ideas first), submitter name or organization, target industry, idea category, and related products.

4. The ability to archive deferred ideas for later reference and reuse.

5. The ability of all registered users to comment on an expand upon each idea in the database, including the addition of attached files adding further explanation.

6. The ability to automatically generate invention disclosure forms that can be used to initiate the invention disclosure submission process.

7. The ability to track the status of ideas and vote on submitted ideas through on-line status fields and through automatically generated e-mails. The automatically generated e-mails can be used to alert management of new submissions and to communicate status and changes to previously submitted ideas.

8. The system enables management to rate ideas, providing a summary view of all other ratings on-line used to qualify and rank submitted ideas. The system also has the ability to hide this level of information to users of the system outside of an idea management team to minimize discouraging the submission of ideas in the future.

9. The ability to enable the author of the idea or the management group to update or edit an idea. This capability allows the tracking of the most recent updates. The edit option would preferably be available only to members of the idea management team.

10. Instructions are included to provide guidance in resolving problems and issues through a consistent contact point.

11. Through responses to specific questions, the submitter will also be able to assess and quantify preliminary risks inherent to a specific idea through linkage with a risk model adapted for the idea submission system.

The Idea Shop has a number of purposes. One purpose is to increase the volume, diversity and quality of ideas captured and developed by business units (BUs) in an organization in order to improve the success of idea realization, maximize solution impact and decrease risk of market failure of solutions. As described in further detail below, the Idea Shop accomplishes this purpose through on-going design and support of idea collection/capture activities, and focused research and evaluation of inherent risk in selected ideas resulting in reduced time and managed risk in concept development and selection, thus providing a ready selection of pre-screened concepts.

It will be appreciated that the Idea Shop allows a business enterprise to look at ideas early in the development process with a minimal investment of resources. It allows management to review ideas quickly and in an orderly fashion, in order to evaluate the potential returns, as well as the inherent risks, in pursuing each idea. It also allows management to evaluate whether an idea is currently viable or not.

One reason for the development of the present invention is that opportunities are being missed. Currently, there is no consistent nor timely mechanism to encourage, capture and coordinate good ideas from multiple sources throughout an organization. Correspondingly, new concept funnels may be virtually empty in some business units. This makes quality portfolio management and planning difficult due to lack of development alternatives. Strategic action must be taken to promote the flexibility required by a marketplace of more agile competitors.

The Idea Shop is directed to systems and methods designed to encourage and capture ideas generated by an organization's associates and customers, and then to research and define new solution concept proposals, within its scope, for presentation to a Resource Board for evaluation against portfolio management goals. One aspect of the Idea Shop provides two main components, idea generation and opportunity screening.

For the purposes of the present description of the invention, an “idea” is considered to be different from a “concept.” An “idea” is defined as any input submitted to the Idea Shop process that influences the completeness and competitiveness of a product line, any cost reduction improving profitability, and opportunities that may fall outside of the existing portfolio and that may be considered at a later time. An idea is an element of a concept. A “concept” is defined as a deliverable product, service, plan of action, or the like, that is the result of opportunity screening in the Concept Phase, as described below. The concept describes a potential offer to proceed further in development.

According to the present aspect of the invention, specific roles and responsibilities are defined for associates within the organization. The number and assignment of Idea Shop roles and responsibilities to associates within the business unit is determined locally, depending on individual goals and resources available to support the Idea Shop process. Idea Shop role requirements, described below, are designed to be flexible. Minimally, a Process Champion is assigned to facilitate and promote the use of the process. Other roles are assigned as needed.

As described below, one embodiment of the Idea Shop includes the following roles: an Idea Submitter, a Process Champion, and an Idea Sponsor. The Submitter, or Idea Owner, makes the initial submission of the idea to the Idea Shop system. The Process Champion owns the management of the process output to ensure that the submitted idea receives appropriate, expedient attention as the idea is developed into a concept, and that concepts that are output from the Idea Shop process also receive appropriate, expedient attention. The Process Champion acts as a human filter, helping to make sure that there is an optimum number of ideas in a business organization's idea funnel, and to build upon the process, tuning it based upon feedback. The Idea Sponsor provides resources necessary for the development of the idea and completing the initial business assessment described below.

The Idea Shop process depends on consistent and ongoing management and activity. Similar initiatives have failed due to a lack of high level support and participation, and lack of consistent follow-through. The Idea Shop may be considered as a long-term investment in the health of an overall solution funnel.

The exemplary Idea Shop process described herein may serve as a blueprint or initial framework from which to build an Idea Shop in each business unit within an organization. Certain implementation details are flexible, in order to leave room for each business unit to adapt and grow the process to meet its business needs and resources. As practitioners gain implementation experience, the process will evolve accordingly.

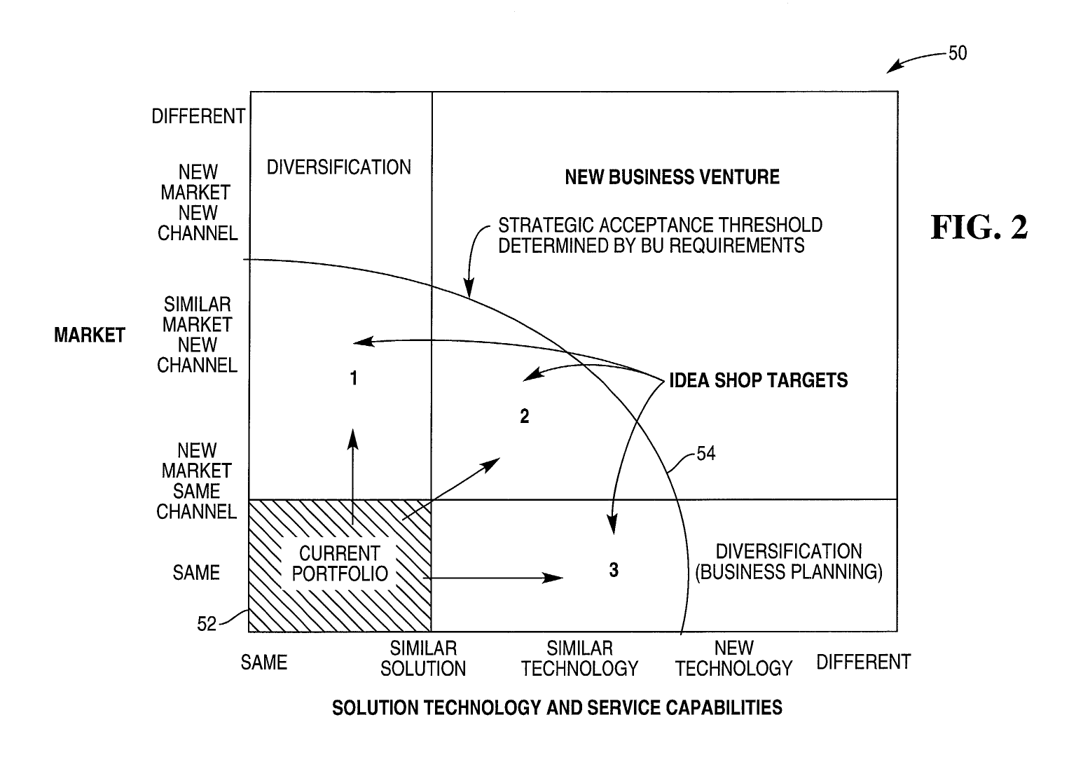

The present embodiment of the Idea Shop can be used to leverage a business enterprise's current portfolio of products and services. This aspect of the Idea Shop is illustrated in FIG. 2, which shows a graphical model 50 in which the marketplace is mapped again a business enterprise's solution technology and service capabilities. The business's current portfolio is illustrated as a shaded rectangle 52 at the lower left corner of the graph 50. New business ventures can be mapped onto the graph 50 by analyzing the technology required by the new business venture, as well as the marketing channels required by the new business venture, and quantifying how much these components of the new business venture differ from the current portfolio 52. Thus, for example, a new business venture may use technology that is already in the possession of the business enterprise, but may require expansion into new marketing channels. Such a business venture would be mapped onto the graph above the current portfolio. Another business venture may use already existing marketing channels, but may require the development of new technology. Such a business venture would be mapped onto the graph to the right of the current portfolio. Finally, a business venture might require both the development of new technology and new marketing channels. Such a business venture would be mapped onto the graph 50 above and to the right of the current portfolio 52.

From the point of view of efficiency and profitability, it is desirable for the business enterprise to be able to take advantage of any leverage afforded by the current portfolio. Such leverage includes, for example: technological expertise, market research availability, established sales channels, current markets, vendor's reputation in solution class, aligned and proven partners, and professional and customer services capabilities. The chart 50 shown in FIG. 2 includes a line 54 defining a “strategic acceptance threshold,” which is determined by business unit requirements. New business venture ideas falling within the strategic acceptance threshold leverage existing technologies and marketing channels, and may be thought of as “low hanging fruit.” Such business ventures are often less risky, may block out potential competition, and may achieve greater market success. Thus, the Idea Shop may be used to develop and present these types of business venture ideas.

Successful solutions typically start with solid ideas and well-researched solution concepts. The greater number of ideas an organization has to choose from, the better its chances of picking a winner that fits the portfolio, drives extended profitability potential, and enhances the product offering within the portfolio. But, merely increasing the number of ideas and concepts is not sufficient unless those ideas support business unit goals. The best ideas will leverage the core competencies of the business unit from technology alignment to services delivery capabilities. They will be derived from many varied sources including customer needs and technological advancements.

No matter how good the concept, market success is unlikely if the timing is wrong, that is, too early or too late. Market timing is a key success factor for any solution introduction. Companies must make the best decisions with the information at hand to swiftly develop and introduce new solutions into a rapidly changing marketplace. Therefore, concepts must be developed quickly, without sacrificing quality, and a decision made on better-focused information that is packaged in fewer deliverables than are typically generated under current practice and processes (such as the Global Realization Process, mentioned above). The goal is to present enough information about a concept in a short period of time to enable a Resource Board, or other suitable committee within the organization, to make a prudent business decision whether or not to fund the resources to create a full-blown business plan.

The Idea Shop can be used in conjunction with a business model that includes a defined “concept phase,” in which a concept is pulled together in a short period of time. Since only a small amount of effort is invested, a company can afford to review many concepts, thus promoting creativity. According to this model, a large number of concepts are screened through the Idea Shop, which as described herein systematically weeds out weaker concepts and allows the organization to concentrate on and develop only the best solutions with the highest potential and business focus.

There is no formal mechanism currently in place to collect, evaluate and leverage ideas from multiple sources into concepts in an idea development funnel. Capturing customer feedback, industry information, technical advancements and market needs is performed on an inconsistent ad hoc basis through disparate non-linked functional areas. Potentially exciting synergies are lost. Balancing the percentage of incremental improvements in technology portfolios versus percentage of totally new solutions and strategic high-risk projects is also often ad hoc.

In response to these needs, the Idea Shop process is designed to accomplish a number of goals, including: defining current market decision criteria for use in the evaluation of new concepts; evaluating and screening new ideas with respect to business unit goals and market requirements; driving market-focused concepts that leverage business unit core competencies and align with strategic plans into development; providing and maintaining a searchable archive of ideas and program concepts; and reducing concept phase duration to an ultimate goal of 2-4 weeks, depending on complexity and sophistication of the concept.

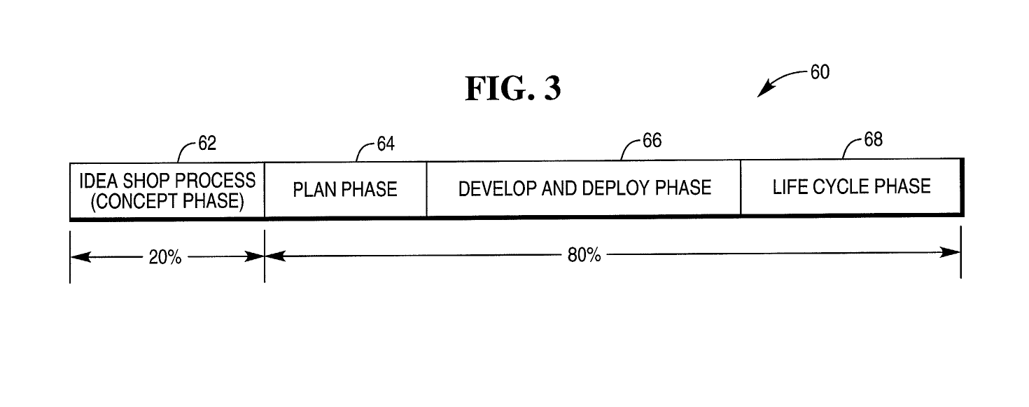

It should be noted that the concepts that are developed using the Idea Shop process may be then used in any way that the business enterprise sees fit. FIG. 3 shows a diagram of an exemplary Global Realization Process 60 that incorporates an embodiment of the Idea Shop. It is important to note that although the Idea Shop is an excellent avenue for idea submission as part of the Global Realization Process, the Idea Shop can be implemented as a stand-alone process without the becoming an integral part of Global Realization Process. As shown in FIG. 3, the Global Realization Process 60 includes a Concept Phase 62, a Plan Phase 64, a Develop and Deploy Phase 66, and a Life Cycle Phase 68. The Idea Shop is used in the Concept Phase 62 of the Global Realization Process 60. However, the Idea Shop may also be used independently of the Global Realization Process, depending upon the needs of a particular business enterprise.

The Idea Shop process allows portfolio management/leadership teams to evaluate concept ideas before extensive development money is spent on ideas that fail to fit the business model or are especially high risk. Concept Phase 62 deliverables are designed to feed directly into business case planning in the Plan Phase 64, during which they will be expanded into a solution business plan by a technology development team.

The portfolio management team for each business unit will establish research and develop (R&D) investment classifications and goals for solutions and solution concepts. The Idea Shop has a significant business impact, including ongoing design and support of idea collection/capture activities. The Idea Shop provides a clearly defined automated link to the realization process for all potential Idea Submitters throughout the organization, and further provides: the opportunity to combine and reframe submitted ideas into high-potential concepts, the opportunity to support and direct creative people throughout the organization, and the opportunity to lock out competition through the filing of earlier patent applications consistent with the broad concepts of ideas.

The Idea Shop further enables focused research and evaluation of inherent risk in selected ideas early in the evaluation process, much earlier than is advocated in typical current business models. Specifically, the Idea Shop provides tools to quickly evaluate concept risk prior to investment in a business plan, significantly shorten the time required to evaluate an idea/concept, assess risk consistently across all concepts, and provide a baseline risk assessment for comparison with Plan phase assessment. In addition, the Idea Shop provides a selection of pre-screened concepts, and provides an opportunity to select the best concept for investment based on potential return on investment (ROI) and assessed risk of the idea versus current portfolio offerings, the need to effectively reallocate resources, and portfolio balancing goals.

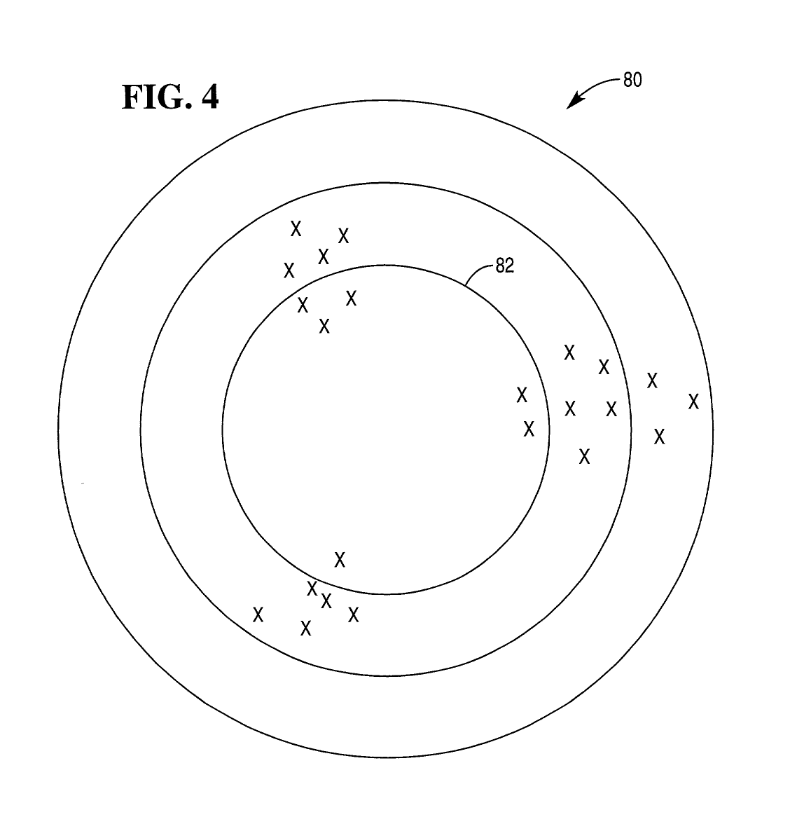

FIG. 4 shows a “target” model 80, which can be used to conceptualize the functioning of the Idea Shop system. The bull's eye 82 of the target represents the desired amount of departure from technology and marketing channels in the current portfolio. By their nature, ideas, represented by x's in the model 80, are often generated in clusters. If a significant volume of new ideas is generated, it may be difficult to determine which ideas to develop. However, using the Idea Shop, a business enterprise may efficiently determine which of the generated ideas fall within the bull's eye 82 and devote its resources to developing those ideas, while not wasting resources on ideas that fall outside of the bull's eye 82.

In addition, the Idea shop reduces time and manages risk in concept development and selection. In particular, the Idea Shop helps manage realization process risk by allowing early identification of risks, a jump start on risk-contingency planning, reduced cycle time to develop concept to decision point, identification and documentation of a more comprehensive list of ideas/opportunities that might otherwise be lost, and an increased number and quality of development alternatives.

According to the present invention, the Idea Shop includes two phases: the Idea Generation Phase and the Opportunity Screening Phase. Each of these phases is described in greater detail below. As explained below, the Idea Shop process culminates in a decision point, where the decision is made whether to proceed with the submitted idea to the next phase of development.

The first phase of the Idea Shop is Idea Generation. In order to facilitate the generation of ideas, Idea Generation programs are developed, maintained, and supported by an associate of the organization who is appointed to be an Idea Owner. An Idea Generation program may require several months to establish, in order for the business unit to generate enough submissions necessary to drive the Idea Shop process. Implementation time frame and planning scenarios are described in greater detail below.

Idea Generation activities include: encouraging and supporting the collection of ideas from multiple sources within and outside the business unit, combining input from various sources to generate new ideas, evaluating ideas for strategic fit, competitive advantage and leverage opportunities, and choosing the best ideas to be developed into concepts for presentation to the Resource Board/portfolio manager, ensuring patent protection of invention is engaged when appropriate, and maintaining an up-to-date searchable ideal concept archive accessible to all business units.

One feature of the Idea Shop is that it provides access to ideas captured in field engagements that would otherwise become buried in notebooks and have no easy avenue for their sharing or further development. Good ideas can come from any number of sources within and outside of an organization. There is rarely a shortage of ideas within a company. Even given good intentions, idea collection activities are difficult to sustain long-term. Non-dedicated idea collection resources are easily diverted, often never returning to this task. The challenge faced by a typical organization is the consistent collection and timely evaluation of those ideas Idea generation/collection activities include, but are not limited to the following:

1. Developing key Idea Champion contacts in key functional areas, including, but not limited to sales, customer and professional and customer services, marketing, product/solution management, and human factors. These Champions will act as contact points for the concept team. They will help support and encourage individual idea submission from people in their functional area.

2. Planning and holding regular focus groups or working brainstorming sessions with both customers and employees. There are a number of good idea generation exercises that have been developed for groups that could easily be re-focused for use in the Idea Shop.

3. Researching and evaluating licensing/acquisition opportunities.

4. Leveraging university and advanced development technical research.

Whenever possible, Idea Shop practitioners, especially Management Screening Committee members, should have broad-based experience and established networks throughout the business unit. The ability to develop and leverage personal networks is critical to the committee, enabling them access to a broad information base that may help spawn new concepts.

Ideas or other inputs to the Idea Shop are not limited to potential solution descriptions. Contributions may also come in the form of customer and professional services customer engagement records of customer problems; noted market trends including social, technical, environmental, demographic, and political factors; insights into competitor behavior; applicable new technologies and software or service capabilities, and field based development engagement results through knowledge management. Further, these inputs can be combined and developed by Idea Shop practitioners (including the Management Screening Committee) or by focus group participants.

Although any submission format will be accepted, ideas from individual submitters can be enabled by an electronic idea submission/justification interface connecting directly into the central archive database where such a database is in place. The Process Champion provides support for this tool. Idea Shop practitioners may follow up with the Idea Submitter to further understand the idea and to uncover any additional information the submitter may have.

An internal marketing campaign that clearly explains the process for submitting ideas and the rewards, both extrinsic and intrinsic, of contribution will support individual idea contributions and participation in focus groups. Through these programs, submitters are trained to recognize the scope of ideas wanted and the thresholds of risk that a given business unit is willing to accept. Thereby, they learn to appreciate why an idea may be accepted or deferred. Ideas submitted by customers and associates of the organization are recognized and rewarded appropriately to strengthen the relationship and reinforce future input for ideas.

Idea Generation is an ongoing process, that includes encouraging, supporting, collecting and archiving ideas from multiple sources within and outside the business unit led by the Idea Shop Process Champion.

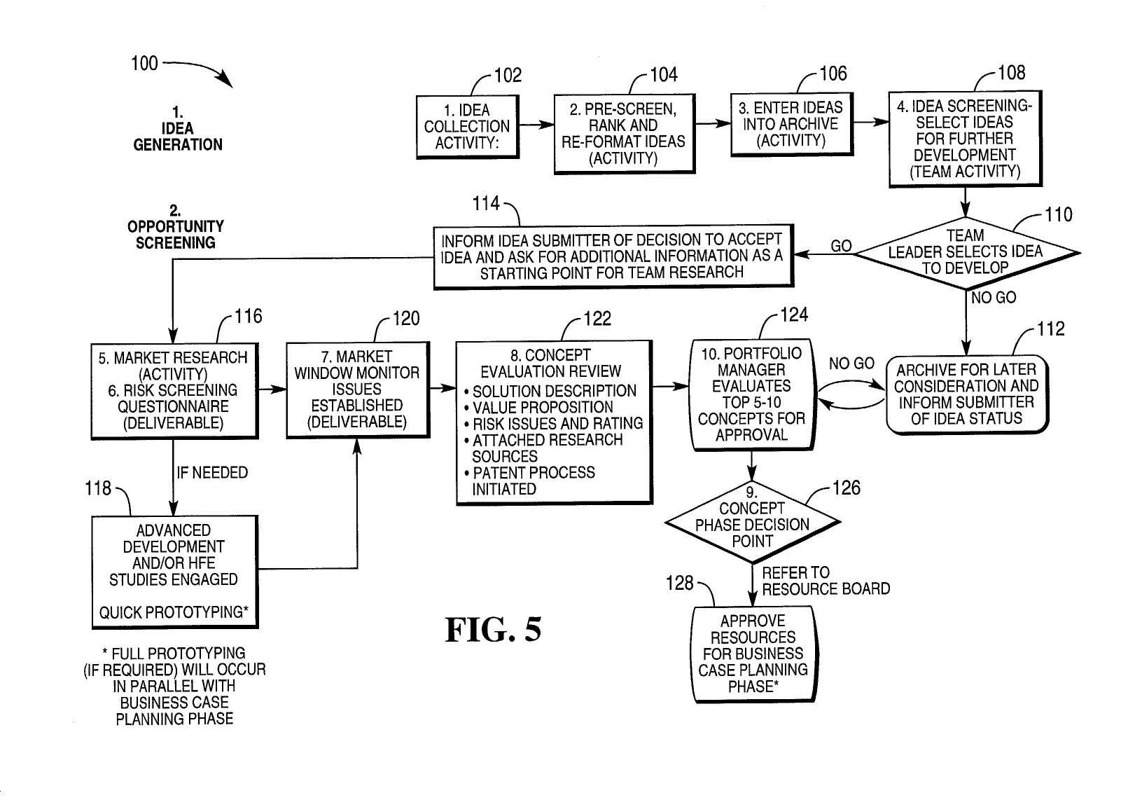

FIG. 5 shows a flowchart of an embodiment of an Idea Shop method 100 according to the present invention. As shown in FIG. 5, the method 100 includes two main components, an idea generation phase and an opportunity screening phase. The first step 102 of the method comprises idea collection activity. In step 104, the collected ideas are pre-screened, ranked, and reformatted, as needed. In step 106, the ideas are entered into an idea archive. Step 108 comprises idea screening activity, in which ideas are selected for further development. In step 110, the decision is made by a team leader as to whether to proceed with the development of a particular idea. If the decision is made to defer action on the idea, that is, if the idea is determined to be a “no go,” then in step 112 the idea is archived for later consideration, and the Idea Submitter is informed of the status of the idea.

If the decision is made to develop the idea, that is, if the idea is determined to be a “go,” then in step 114, the Idea Submitter is informed of the decision to accept the idea and is asked for additional information as the starting point for team research. Step 116 comprises market research and a risk screen questionnaire. If needed, in step 118 there is advanced development of the idea and or human factors engineering (HFE) is engaged. There may also be quick prototyping of the idea. Full prototyping, if required, occurs in parallel with a business case planning phase.

In step 120, market window monitor issues are established. Step 122 comprises a concept evaluation review. This includes: solution description, value proposition, risk issues and rating, attaching research sources, and initiating the patent process. In step 124, a Portfolio Manager evaluates the top five to ten concepts for approval. If a concept is not in the top group, then the method proceeds to step 112, in which the concept is archived for later consideration, and the Idea Submitter is informed of the status of the concept. If the concept is in the top group, then in step 126, the method reaches a concept phase decision point. If the decision is made to proceed, then the concept is referred to a resource board, and in step 128, resources are approved for a business case planning phase.

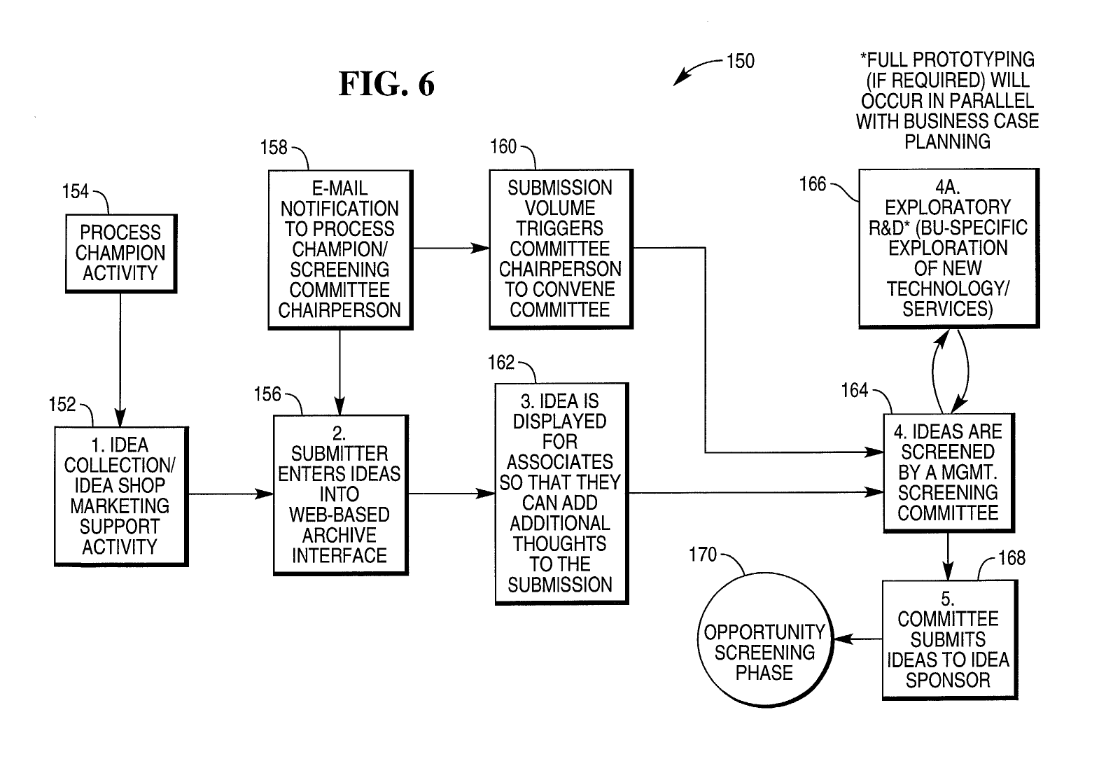

FIG. 6 shows a flowchart illustrating the Idea Generation Phase 150 of the Idea Shop in greater detail. As shown in FIG. 6, the first step 152 of the Idea Generation Phase 150 includes idea collection, as well as marketing support activity. In step 154, step 152 is managed by a Process Champion. In step 156, Idea Submitters enter ideas into a web-based archive interface. In step 158, each submitted idea is forwarded by e-mail to the Process Champion, and to a screening committee chairperson. In step 160, the submitted ideas are reviewed by the screening committee chairperson until the volume of submissions triggers the chairperson to convene a meeting of the committee. In step 162, which proceeds in parallel with step 160, the idea is displayed for associates of the organization so that they can add additional thoughts to the original submission. In step 164, the ideas are screened by a Management Screening Committee. The management screening committee should function as a “brain trust” that includes upper echelon management and the business enterprise's best strategic thinkers and business visionaries. In step 166, the Management Screening Committee refers promising ideas for exploratory research and development. As indicated on the flowchart, full prototyping, if required, occurs in parallel with business case planning during the exploratory research and development. In step 168, any ideas that continue to be promising, after exploratory research and development, are submitted by the Management Screening Committee to an Idea Sponsor, and these ideas then in step 170 enter the Opportunity Screening Phase, described below.

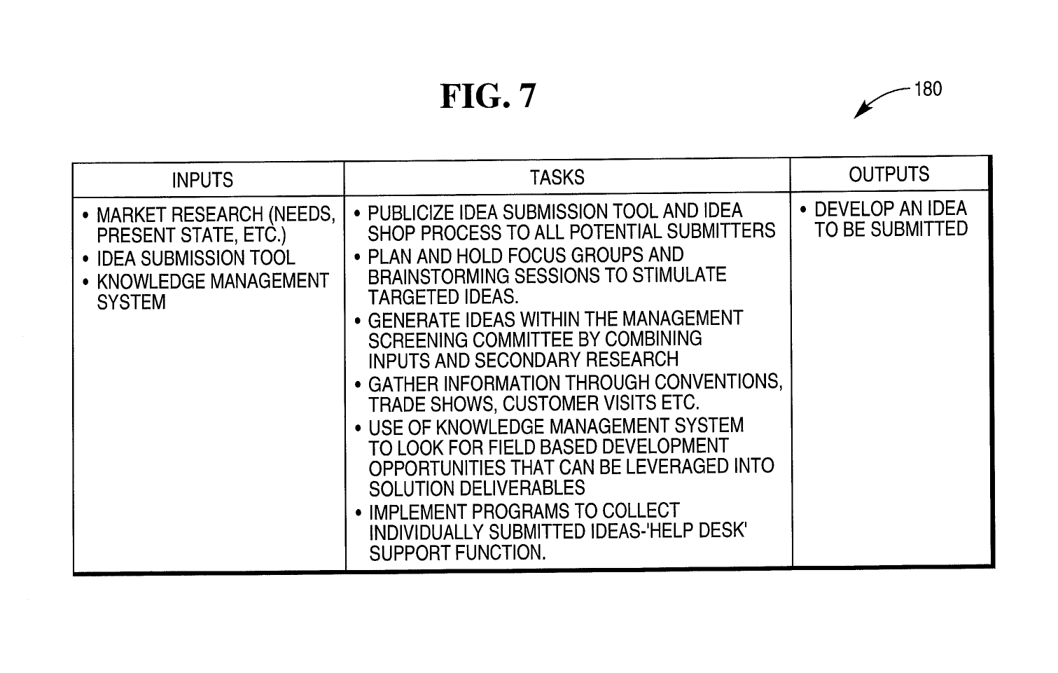

Each step within the Idea Generation Phase is now described in further detail, including relevant inputs, tasks, and outputs. The idea collection activity of step 152 is illustrated in the table 180 shown in FIG. 7. The idea collection activity is owned by the Idea Submitter and by the Idea Shop Process Champion. The idea collection activity includes the gathering of data combined with the use of the tools in order to create new ideas.

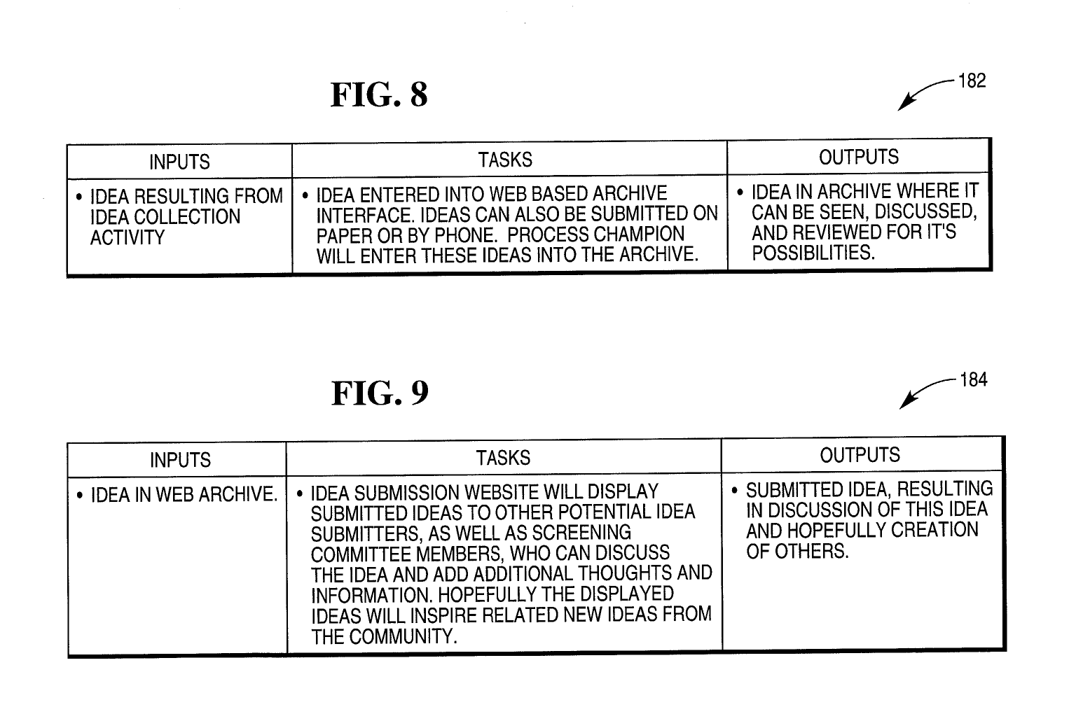

In step 156, the idea is submitted into a web-based archive interface. This is illustrated in the table 182 shown in FIG. 8. The submission of the idea is followed by making the idea generally available to the community of Idea Submitters in step 162. In this step, the idea is displayed through the web archive for other submitters and screening committee members to see and discuss. Step 162 is illustrated in the table 184 shown in FIG. 9.

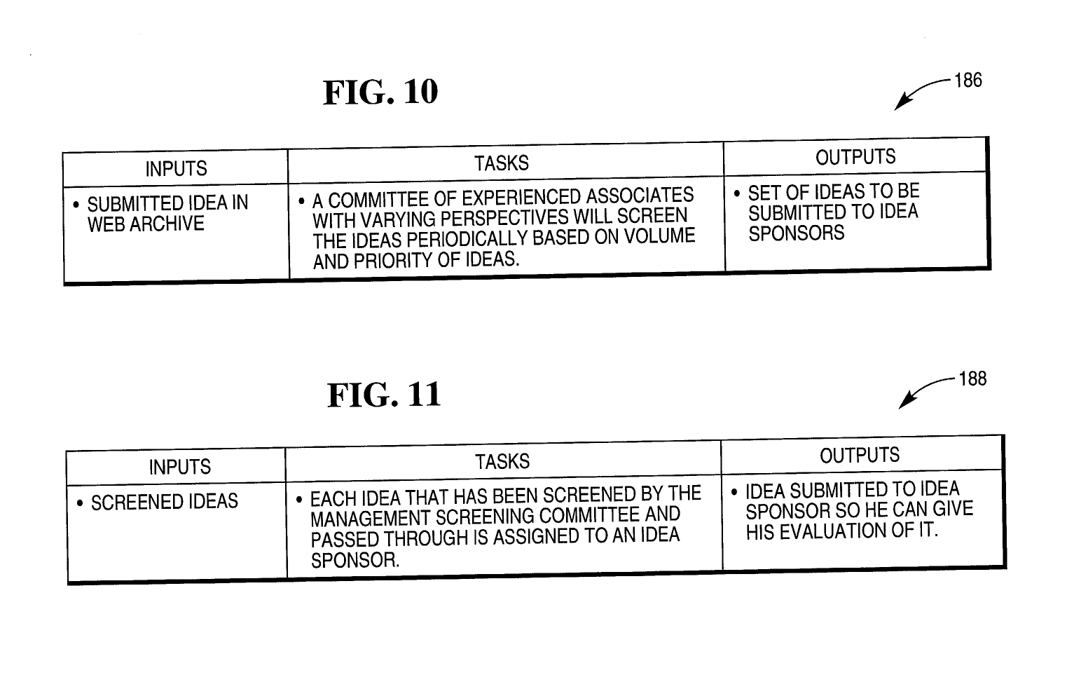

The idea screening in step 164 is owned by the Management Screening Committee. This step is illustrated in the table 186 shown in FIG. 10. In this step, the Management Screening Committee screens ideas to decide whether or not they should be researched further for possible use. The next step, step 168, is submission of selected ideas to an appropriate Idea Sponsor. This step is illustrated in the table 188 shown in FIG. 11. This component is owned by the Management Screening Committee. After an idea has passed through screening, the Management Screening Committee assigns a sponsor to each idea that it wants researched further.

Thus, according to the present invention, numerous roles and responsibilities are assigned to associates of the organization. These roles and responsibilities include the following:

Idea Submitter. The Idea Submitter submits ideas, and may further act as a subject matter expert consultant for concept development.

Process Champion. The responsibilities of the Process Champion may include, but are not limited to: encouraging idea submission; receiving phone submissions and answering submitter questions; facilitating the movement of ideas into a planning phase wherever possible; promoting and encouraging idea submission; developing and conducting idea collection activities; managing reward and process support programs; tracking ideas throughout the Idea Shop process; following up with Idea Submitters; generating and communicating metrics reports; and ensuring all supporting research, risk tool and presentation is entered into database for each idea.

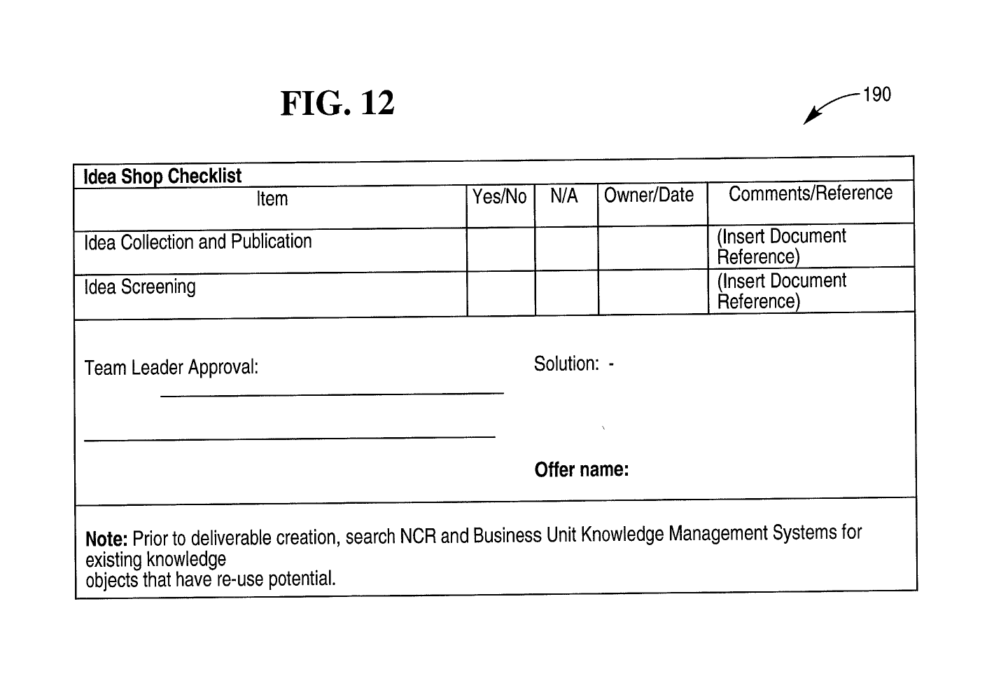

FIG. 12 shows an exemplary checklist 190 for use in the Idea Generation Phase. The following guidelines are provided for the checklist 190. “Idea Collection and Publication” includes information gathered through conventions, trade show, and other sources, as well as ideas submitted into a web based archive for display to others. In the “Idea Screening” component of the checklist, an Idea Management Committee gets an idea from the idea submission web site and screens it for its possibilities, and an Idea Sponsor is assigned if that Idea is approved.

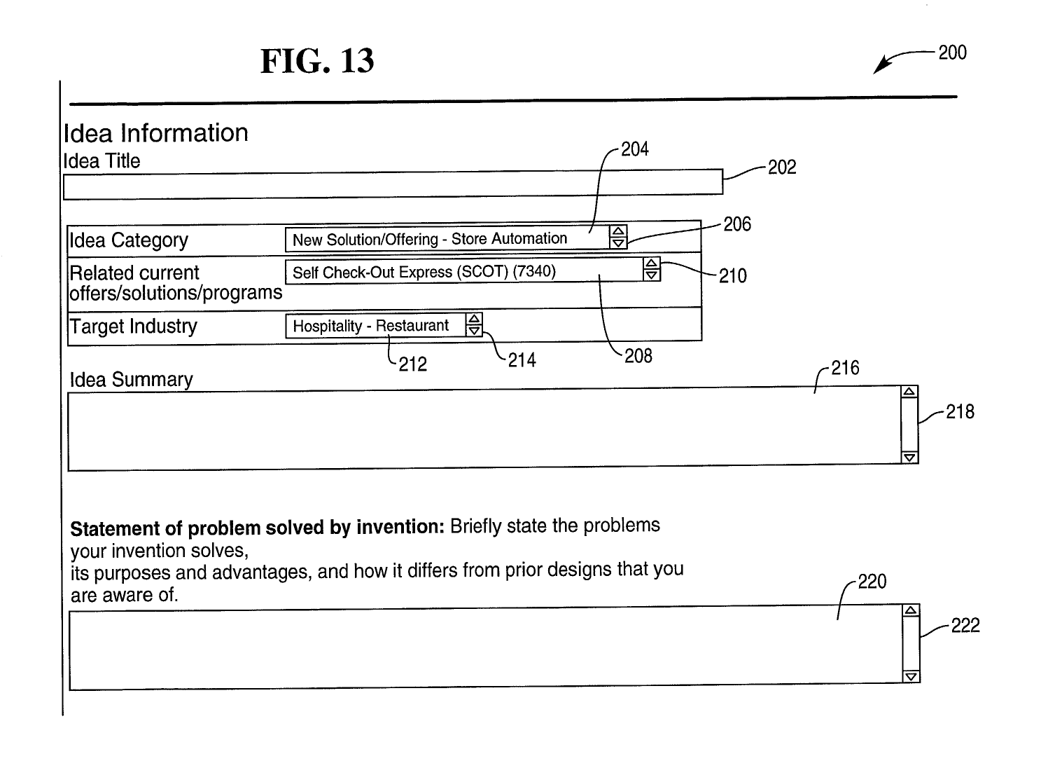

The Idea Generation Phase of the Idea Shop utilizes a number of tools, documents, and exhibits. These include the Idea Submission Tool, and the Searchable Idea/Concept Archive. FIG. 13 shows an exemplary Idea Submission Tool 200 used in a Retail Solution Group. As shown in FIG. 13, the Idea Submission Tool comprises a computer display screen that can be replicated onto a local Notes server and easily adapted to meet local business unit goals and requirements. In the present embodiment, access to the tool is regulated using a password security system that is managed through an associated registration database. Registered users can then be named to defined groups that have access to defined areas of the database. Access is limited to associates within the organization's firewall, but can be further managed to define access to specific views. For example, this security system may allow only the original Idea Submitter to edit the idea.

The Idea Submission screen 200 includes a number of boxes for input of data. A first box 202 is used for the title of the idea. Idea Categories are predefined, and are selected by clicking on the up and down arrows 206 on the right side of the “Idea Category” box 204. Similarly, already existing related current offers, solutions, and programs are also defined and selected by clicking on the up and down arrows 210 at the right side of the “Related current offers/solutions/programs” box 206. The target industry is similarly selected by clicking on the up and down arrows 214 at the right side of the “Target Industry” box 212. A summary of the idea is entered as text into the “Idea Summary” box 216. If the summary is lengthy, it can be scrolled up and down using the scrollbar 218 at the right of the box 216. At the bottom of the screen is a box 220 entitled “Statement of problem solved by invention,” in which the Idea Submitter states the problem solved by the invention. A scrollbar 222 is also included.

The following is an overview of how various people in the Idea Shop process will use the Idea Submission Tool illustrated in FIG. 13. The Idea Submitter is able to submit and edit the idea, automatically generate an invention disclosure form for submission to the patent process, track the idea status, and rate and add information to enhance other people's ideas. The Process Champion will have full editing access through a Lotus Notes client that will need to be licensed and installed on his/her computer. This will enable the Process Champion to update the status of ideas, defer idea submissions that fail to meet business unit submission criteria, and update security access permissions. Management Screening Committee members can read and rate ideas prior to screening meetings so that only top ideas are discussed live. The database can be programmed to send automated e-mail notifications, such as alerting the Process Champion and Management committee members of new submissions in the database or notifying Idea Submitters of changes in the status of their ideas.

The present embodiment of the Idea Shop further includes an interactive archive/database, which includes an electronic archive of all ideas collected by the concept team. Therefore, a key on-going function of the team is the maintenance of the database where the ideas are stored. To ensure that this administrative function is performed consistently, the team's performance may advantageously be measured in part by the number of ideas documented in the database.

Archived ideas should be leverageable. This means that a person looking for scanners in the food industry will be able to easily find all related ideas in the archive. Thus, in the present embodiment of the Idea Shop, the archive is provided with a keyword search function that enables related ideas to be combined later. The interface is flexible and easy to use for an Idea Submitter, Idea Shop team member, Resource Board member, or anyone else using the system.

The use of keywords enables future users of the database to pull all related ideas in order to leverage them into new solutions. This process is linked into the organization's corporate knowledge management system. The end goal is a convergence of idea submission into one central repository that is accessible to all appropriate employees to stimulate creativity.

There are a number of requirements for the archive database. First, the archive must be capable of linking MetaData to Idea Knowledge Objects. Some ideas for MetaData (attributes) include, but are not limited to: date entered in system; rating of idea and date of rating; date of decision point; status of idea submission; department/individual that generated the idea; portfolio(s) in which the idea would fit; related solutions in the current Portfolio; related products/solutions in the current product line; related markets into which the solution could be introduced; nature of competitive advantages, including technical competency, first to market, or the like; specific strategic plans met; customers involved in generating/recommending the idea; potential partners; and potential competitors.

In addition, the Idea Shop provides advanced search capabilities to allow users to find the information they are looking for. The advanced search capabilities will enable related ideas to be linked, and for their use to be tracked. In particular, the advanced search capabilities enable users of the Idea Shop to search across business units, based on leverageable dimensions. These dimensions, or keywords, roll into higher level keywords so that they are captured by the higher level search. A retail solutions group example, something related to a specific point of sale terminal can be automatically classified under “Store Automation” and under “Terminals” as well as under a model number or other identifier for the terminal. Since some of these search parameters will be somewhat intuitive, the database will provide the option to search entire documents for specified, non-programmed keywords.

The Idea Shop is designed for ease of use and flexibility. The interface for the archive is customizable for ease of use specific to Idea Shop regular activities. For example, a team will be able to customize buttons and choices on an interface to minimize keystrokes needed to access frequently used information. In a present embodiment, the idea submission tool is configured to archive data in Microsoft Access format. Ideally, a knowledge management system will be able to interface with input from this tool. Appropriate firewall security will be provided.

The system further provides metric calculation and reporting. In a further embodiment of the invention, the tool is able to create automatic reports. Samples of the types of reporting available include: total elapsed cycle time from selection/receipt of idea to the decision point; number of ideas archived per month; idea source frequency distributions; number of repeat individual submissions; number of ideas received/per time frame; number of “hits” on the database; a list of all ideas related to this industry, group by whether the idea has been accepted or deferred; the number of ideas that are being deferred throughout the organization, grouped by type of submitter, such as customer, business units, or the like; how many ideas have been accepted versus deferred; revenue generated by ideas accepted in each business unit; and average processing time of an idea in each business unit. Connecting into a knowledge management system will potentially enable a user of the system to link into information tracked as part of an overall business model.

The second phase of the Idea Shop is the Opportunity Screening Phase. Opportunity Screening activities include: developing ideas into concept evaluation review presentations through use of direct access secondary market/competitive research; rating and ranking ideas in alignment with strategic goals, portfolio fit, organizational core capabilities, corporate risk model, and the market window issues; regularly elevating the best concepts to a Resource Board/Portfolio Manager for evaluation against the existing portfolio; championing and driving the strongest concepts into the next developmental phase.

The Management Screening Committee ranks and sorts ideas based on business unit goals, strategies and core competencies within the division. To a certain degree, the ability to select the highest potential ideas is a function of the experience, insight, and intuition of the selectors. Since this factor is difficult to quantify solely through the use of ranking frameworks, a “panel of experts’ should make idea/concept ranking decisions. This Management Screening Committee should, ideally, be made up of experienced people representing diverse functional perspectives from the business unit. Committee members must be sensitive to market changes and other subtleties not easily captured by static rating exercises.

As a starting point, ideas should be screened on the basis of the degree to which they leverage existing programs to fill portfolio gaps. Ideas should also be rated on the number of core competencies that they leverage including: technological expertise; market research availability; established sales channels; current markets; the organization's reputation in solution class; aligned and proven partners; and professional and customer services capabilities.

Although engineering/technical representatives may seem to be the obvious choice for membership, Marketing, Sales or Customer or Professional Services perspectives are also important, providing bigger picture application or market trend insights rather than purely technical upgrades. Committee membership may change on a regular basis to ensure that personal/organizational biases are balanced.

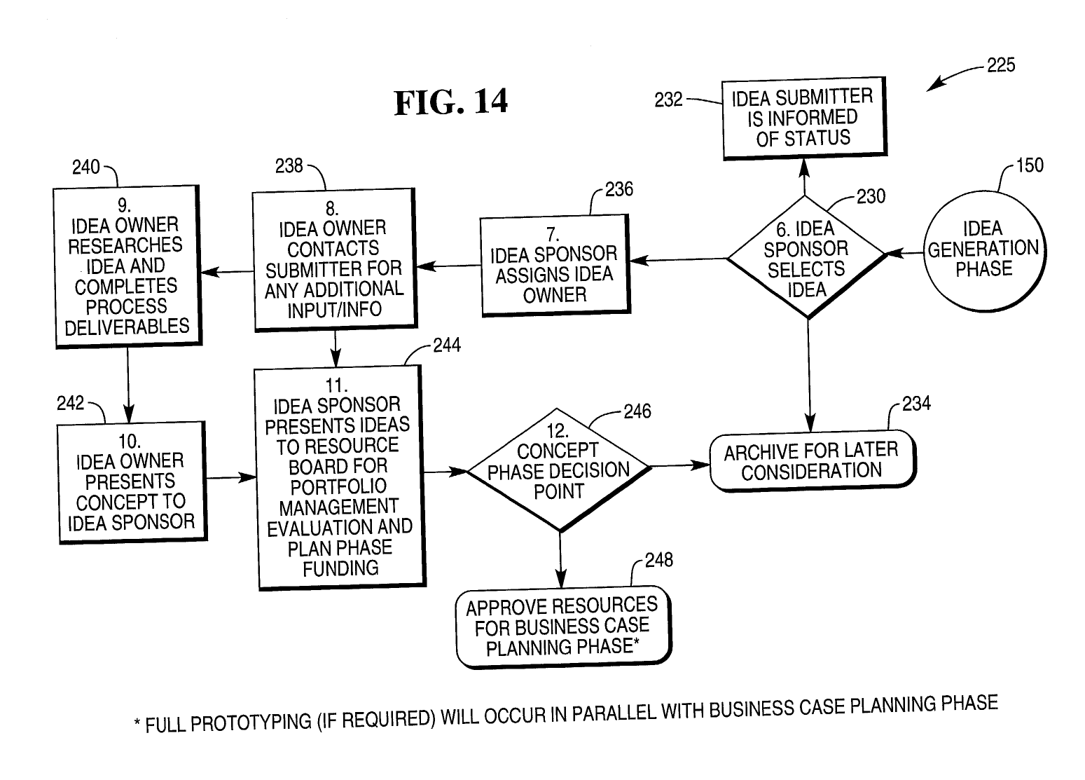

FIG. 14 shows a flowchart of an Opportunity Screening Phase 225 according to a further aspect of the invention. In step 230, the Idea Sponsor selects ideas for further consideration. Three things happen at this point. In step 232, the Idea Submitter is informed of the status. In step 234, the idea, in its current form, is archived for later consideration. In step 236, the Idea Sponsor assigns an Idea Owner for the idea.

In step 238, the Idea Owner contacts the Idea Submitter for any additional input/info. In step 240, the Idea Owner researches the idea and completes process deliverables, and identifies early indicators of risk and potential return on investment. Once this step is completed, the originally submitted idea has now evolved into a “concept,” as defined above. In step 242, the Idea Owner present the concept to the Idea Sponsor. In step 244, the Idea Sponsor presents the idea to a Resource Board for portfolio management evaluation and plan phase funding. Step 246 is the concept phase decision point. If the decision is made to proceed, then in step 248, resources are approved for the business case planning phase. In any event, in step 234, the idea, in its current form, is archived for later use, including possible consolidation with ideas.

In the Opportunity Screening Phase, which lasts 1 to 4 weeks, selected ideas are developed into presentable concepts that can be ranked and evaluated against portfolio needs and to present enough information about a concept in a short period of time to enable the Resource Board to make a decision whether or not to fund a business plan.

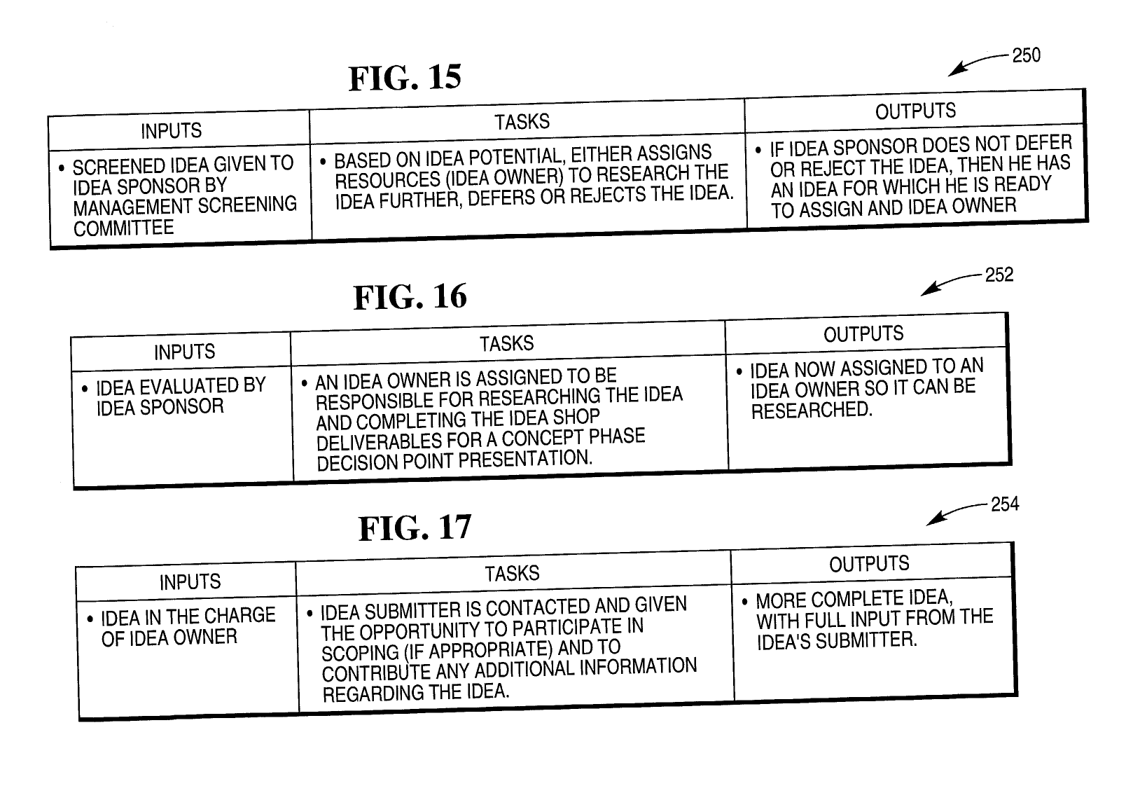

Each step within the Opportunity Screening Phase is described in detail, including relevant inputs, tasks, and outputs. The evaluation of an idea by the Idea Sponsor in performing step 230 in the FIG. 14 flowchart is illustrated in a table 250 set forth in FIG. 15. The process of idea evaluation is owned by the Idea Sponsor. In this step, the Idea Sponsor researches the potential of the idea he or she is sponsoring, and will either defer the idea, forward it to someone else, or assign an Owner to the idea.

In step 236, the Idea Sponsor assigns selected ideas to an Idea Owner, who researches the idea further. This step is illustrated in a table 252 set forth in FIG. 16, and it is owned by the Idea Sponsor. In step 238, the Idea Owner contacts the Idea Submitter. This step is illustrated in the table 254 set forth in FIG. 17. It is also owned by the Idea Sponsor. The Idea Sponsor contacts the Idea Submitter to involve the Idea Submitter in the research process of the idea.

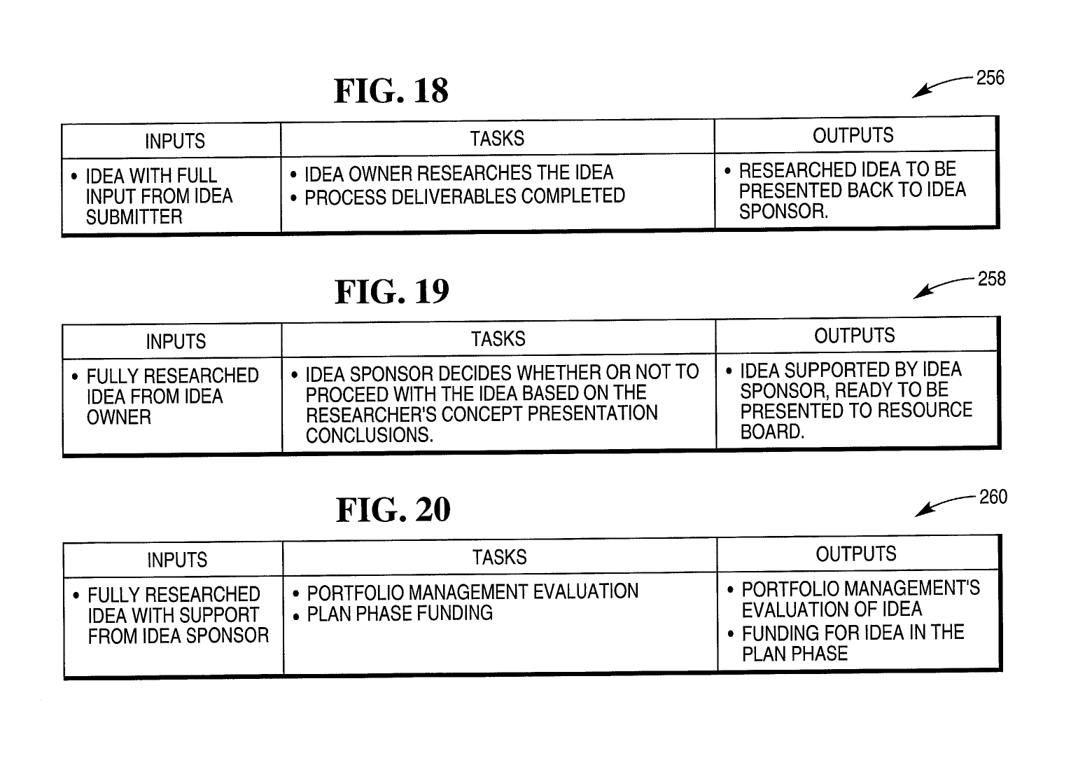

In step 240, the Idea Owner researches the idea. This step is illustrated in the table 256 set forth in FIG. 18, and is owned by the Idea Owner. The Idea Owner researches the idea in order to complete the Idea Shop deliverables. In step 242, the Idea Owner presents research findings to the Idea Sponsor. This component is illustrated in the table 258 set forth in FIG. 19. It is owned by the Idea Owner. The Idea Sponsor decides whether or not the researched idea is to be brought before the Resource Board.

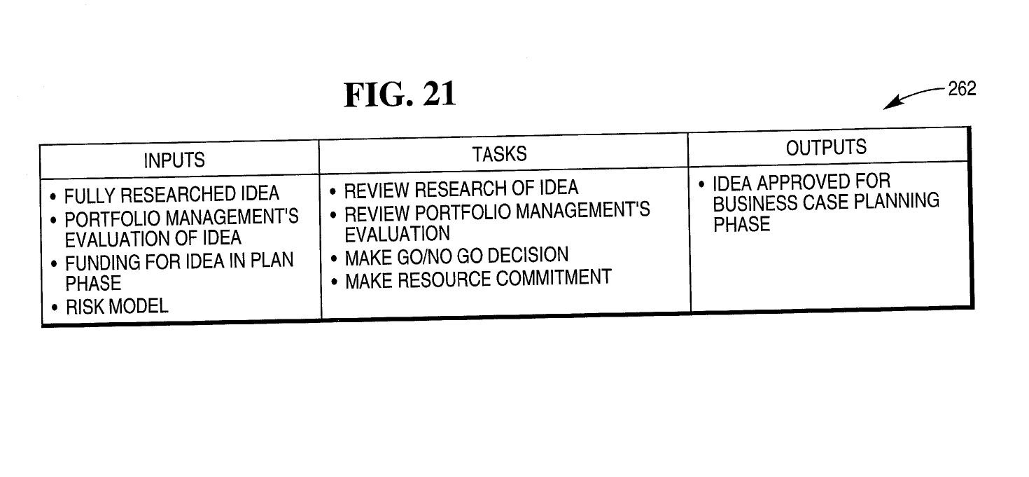

In step 244, the Idea Sponsor presents researched ideas to the Resource Board. This step is illustrated in the table 260 set forth in FIG. 20. Step 244 is owned by the Idea Sponsor and supported by the Idea Owner. Step 246 is the Concept Phase decision point, in which the Resource Board performs a Portfolio Management Evaluation and determines whether to take the idea and move it forward into the next developmental phase. If so, the Resource Board obtains funding for the next phase. Step 246 is illustrated in the table 262 set forth in FIG. 21, and is owned by the Resource Board.

The Opportunity Screening Phase of the Idea Shop assigns the following roles and responsibilities. The Idea Sponsor, typically at the level of vice president, is the resource owner who supports the championing of a selected idea soliciting support from peer senior managers. The Idea Sponsor's responsibilities include, but are not limited to: approving or deferring ideas in a timely fashion; relaying any idea disposition decision to the Process Champion; selecting an Idea Owner for any approved idea; and supporting Idea Shop marketing efforts.

The role of the Idea Owner can be filled by either a financial business planner assigned to the business group or an appropriate product manager, for example, depending on availability and skills required by the idea. The Idea Owner's responsibilities may include: identifying resource and skills needs, including subject matter expert time and secondary market research sources; researching the idea; completing Idea Shop Deliverables including answering risk questions, developing a presentation of findings, presenting specific risks and showstoppers, devising and presenting action/contingency plans to address risks, and presenting the concept to the Idea Sponsor and to the Resource Board.

The Risk Model Owner consults with practitioners when risk model expertise is required. The Subject Matter Expert, including the Risk Model Owner, contributes expertise to answering specific risk and market window information to support the development of a concept and extent of dependencies, such as technological dependencies. The Business Unit Research Coordinator consults on available secondary research sources.

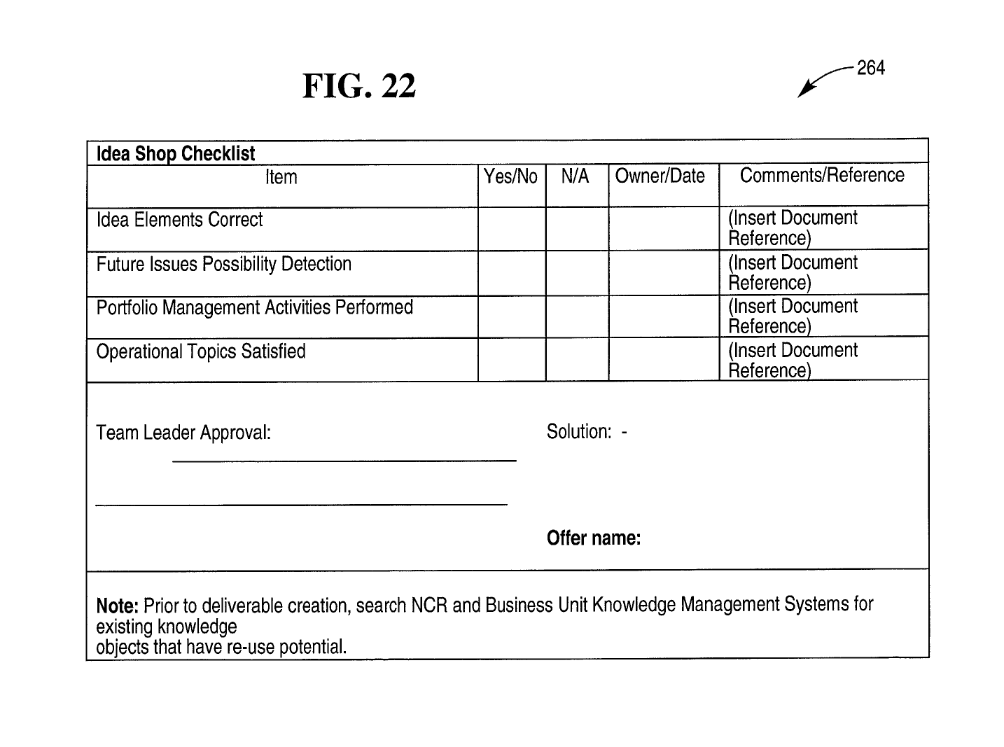

FIG. 22 is a table illustrating a checklist 264 for use in the Opportunity Screening Phase, and includes the following guidelines. “Idea Elements Correct” addresses the following issues: which core competencies and existing components are leveraged by the concept; will the proposed solution satisfy the customer need; identification of key customer or professional services components; and preliminary features and potential architectural compatibility issues. “Future Issues Possibility Detection” addresses the following issues: all key issues apparent in this phase, if any, that may affect the development schedule or introduction timing for this concept; and whether usability and/or user acceptance is critical to offer acceptance and, if so, whether the usability targets are achievable if the idea proceeds directly to Plan Phase. “Portfolio Management Activities Performed” addresses the following issues: comparative level of risk assessed; value added to portfolio. “Operational Topics Satisfied” addresses the following issues: estimates for business case planning phase costs and resource requirements; whether the patent process has been initiated; whether the concept has been archived; and whether the idea Submitter has been notified of the status of the submitted idea.

The Opportunity Screening Phase uses a number of tools, documents, and exhibits.

These include a Completed Risk Screening Questionnaire, a Market Window Monitor, and a Concept Evaluation Review.

The Risk Screen Questionnaire includes the following questions:

Economics:

1. What do you believe is a fair price that a single customer might be willing to pay for an implementation of this idea?

2. Do you believe there is a penalty for not implementing the idea? If so what is that penalty?

3. Please provide your thoughts on the cost of developing this idea including hardware, software, customer and professional services development? (Note: The Idea Shop input tool can provide reasonable ranges for each category and request selection.)

Organizational Issues:

4. Is idea consistent with the organization's strategic direction?

5. Does the solution fill a gap in the Business Unit's solution portfolio?

6. Does the organization have experience in the production and delivery of this idea, or like ideas?

7. Does the idea leverage proven/existing components or technology? Including hardware, software, customer and professional service components?

8. Is there a good architectural fit between the components of the proposed solution?

9. Are development, professional services, and support teams equipped with the skills to implement this solution or is training available?

10. Is high quality, trusted market research data available with which to develop this idea?

11. Is the idea, or portions of idea, patentable?

12. Does implementing this idea require more than 12 months (including any development, internally or through partnership)?

Market/Customer Issues:

13. Has idea been jointly defined/developed with and high customer input and buy-in?

14. Will the implementation of this solution improve our customer's business processes, e.g. save time and/or money?

15. Is there a market demand/pull for the idea already?

16. Does the idea have a verifiable value proposition?

17. Is there a verifiable industry standard benchmark to prove the value proposition?

18. Have we identified appropriate target markets for this solution?

19. Have we identified the specific channels through which to sell the end solution?

20. Is the organization a leader in the target market already?

21. Do we currently have relationships with politically influential people in the industry who can be leveraged?

22. Do we already have a failed image in the market?

23. From a vendor perspective, is the market associated with this idea already mature?

24. Is it likely that the organization can be first to market with this solution?

Competition and Partners:

25. Is competitive threat known and tracked, e.g. competitive information database, including size potential of competitive threat, their strategies, and their presence in targeted markets?

26. Are competitors deeply entrenched into the target accounts?

27. Could competition easily replicate this solution?

28. Are needed partners strategically and operationally aligned?

29. Does the Business Unit have a positive track record with partners required to deliver the solution?

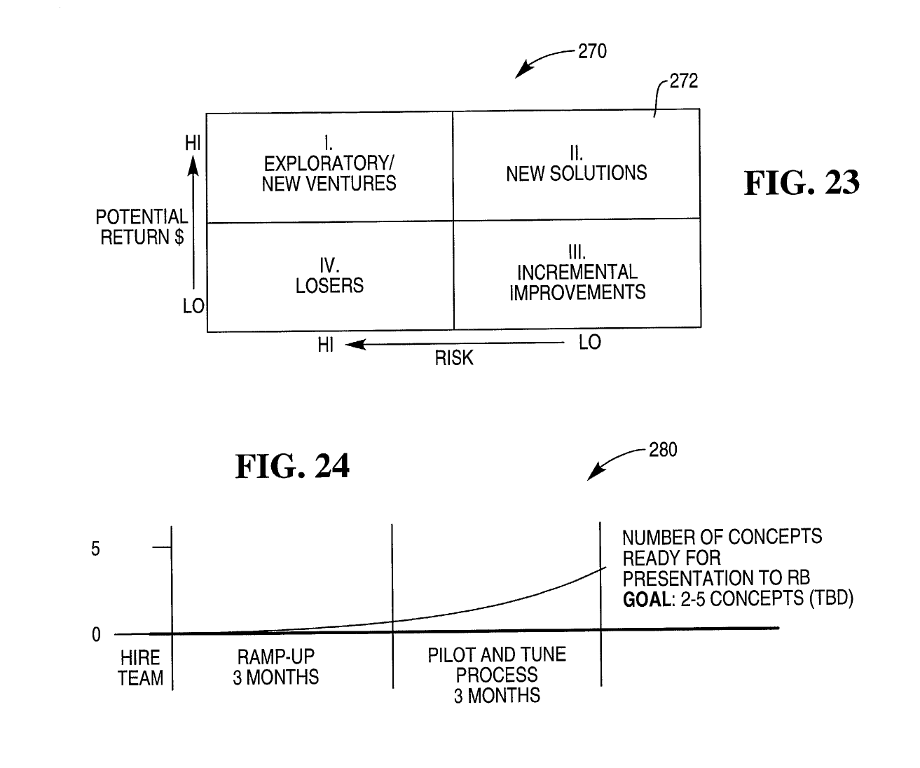

The present embodiment of the invention includes a risk model 270, illustrated in FIG. 23. It is contemplated that the Idea Shop will focus on developing concepts that fall closest to quadrant II (high profit/low risk), focusing on new solutions and those incremental components/services or the like that fall outside current program parameters.

The Idea Shop further includes a Risk Screening Questionnaire that is completed by the Idea Owner as part of the concept evaluation function. The Idea Owner's answers to the questionnaire, which has been adapted to reflect the knowledge available in the concept phase, feed directly into a weighted spreadsheet that calculates a ranking for the idea based on the assumptions in the corporate risk model. A similar questionnaire is part of subsequent phases for update and interlock between phases. The subsequent versions of the risk questions will ask additional questions to reflect the increased information available.

The Idea Shop further includes a Market Window Monitor. The Market Window Monitor in the Idea Shop is the starting point for an on-going reference check of market window-based timing issues. According to this aspect of the invention, the Idea Owner will estimate and document market window length and identify timing issues that will affect successful deployment of the proposed concept. Identified missed window issues will be checked regularly through the development of the program from Idea shop through deployment.

Examples of “missed window” issues include: “all year 2000 activities must cease if the current date is greater than Jan. 1, 2001”; “key competitor has announced the release of similar/same solution while the organization is X months away from launch.”

The Idea Shop deliverables of this activity are: estimated market window time frame; identified specific conditions which would cause the market window to close, including platform issues, competitive/similar solutions enter market, technology shifts/substitutes, environmental changes, or the like. Some of these are concept specific, but many can be generalized across projects. These deliverables will become part of the Concept Evaluation Review.

Subsequent phase deliverables of this activity will include: updated market window time frame estimates in each phase; monitor issues that might jeopardize meeting the market window; and timely elevation of critical market window exceptions to Resource Board.

It is contemplated that managers may be rewarded for identifying and elevating unacceptable risks and other conditions that lead to a voluntary drop or deferred decision. Market window agreement is a pact that risk issues will be evaluated throughout development. The pact is a component of the concept hand off to the managers who are responsible for subsequent developmental phases of an idea.

To sum up the Opportunity Screening Phase of the Idea Shop Process, one important deliverable of Idea Shop is a Concept Review Evaluation presentation and supporting documentation. These deliverables are designed to feed directly into a subsequent organizational business case planning phase.

The Concept Team Concept Phase deliverables include the following:

Completed Risk Screening Questionnaire, described above. The questionnaire responses feed into a weighted spreadsheet that automatically calculates an idea rating based on the assumptions in the corporate risk model. Core team perspective and experience with answering these questions over time will lead to greater consistency of output. The answers will be supported by market research including talking to idea submitters and target customers. Documentation of supporting research should be attached as an appendix to the Concept Review Evaluation.

Market Window Monitor, described above. The Market Window Monitor is used to identify preliminary market window issues that will be carried into the business case planning phase. These issues will enable subsequent business planning to make the decision to kill the project based on market window exceptions.

Concept Evaluation Review. Business Plan templates will be available.

Searchable Idea/Concept Archive, described above.

The Concept Phase Checklist the following questions that the Concept Team leader should be able to answer going into the Concept Phase Decision Point review:

Has the team identified and confirmed:

Concept falls within Idea Shop scope?

Which core competencies and existing components are leveraged by the concept?

The customer need that the proposed solution will satisfy?

Key Professional Services components?

Preliminary features and potential architectural compatibility issues?

All key issues (apparent in this phase, if any) that may affect the development schedule or introduction timing for this concept?

Comparative level of risk?

Value added to portfolio?

Estimates for Business Case Planning Phase costs and resource requirements?

Patent process initiated?

Concept Archived?

Idea submitter notified of status?

A further aspect of the Idea Shop includes a system of measures and metrics that are used to gauge performance. Given the nature of the dedicated concept team, success in these measures should steadily increase over time, as through repetition, the team grows more proficient at the tasks involved in Idea Shop. In order to maintain certain idea rate and thresholds within the funnel while driving a higher rate of approved for ideas submitted, measures of Idea Shop should reinforce:

1. Reduction of concept development time in support of total cycle time reduction initiatives.

2. Increasing number of qualified ideas in the idea funnel over time.

3. Increasing quality of Idea Shop output over time.

4. Cultural support for idea submissions to the Idea Shop.

Thus, the measures and metrics include the following:

Cycle time reduction: Total elapsed cycle time from selection/receipt of idea to concept approval at Concept Phase Decision Point, to determine process effectiveness.

Increased number of qualified ideas in the idea funnel over time: The number of ideas archived per month, to determine process momentum, growth of the idea “pool.” The capture and storage of ideas is a vital output of the Idea Shop. Since consistency of stored ideas and concepts is vital to a full funnel and being able to later combine ideas into better ideas, the team is measured by its consistency in performing this function.

Increased quality of Idea Shop output over time: Number of Idea Shop concepts that reach the Plan Phase Decision point (Gauging process effectiveness).

Cultural support for idea submissions to Idea Shop—Measures of the impact of communication programs: Diversity of idea sources captured by Idea Shop, including number of sources of ideas (high level sources—marketing, customers, Advanced Development, Leadership team, PS engagements etc.), to assess source channel effectiveness, identify dominate sources, managing funnel/pipeline balance; number of repeat individual submissions received; and number of hits on the Archive database.

New programs typically require learning/start-up time to gain momentum and traction in the beginning. The same applies to Idea Shop. Acknowledging and planning for the required ramp-up time is critical to the successful launch of the Idea Shop process. Below is implementation scenario. Depending upon the number of people assigned, a business unit may have to adjust output expectations.

FIG. 24 shows a graph 280 illustrating the startup process. A description of milestones in the startup process follows.

Month 1: (Recommendation: 1 dedicated team leader.) Identify and establish contact with key idea-generation functional champions who are people within targeted functional areas willing to champion idea collection efforts. Rollout and support Idea Collection communication and reward programs BU wide. Test and become familiar with available market research vehicles provided. Refine archive interface for idea submission.

Month 2: (Recommendation: 1 dedicated team leader, 1 full-time business analyst.) Continue to grow and support programs started previously. Plan and hold 1-2 focus groups/brainstorming sessions. Format and archive focus group results and test database search/interface capabilities. Run a pilot test on one idea submitted or generated within the group or team. Review Deliverables generated and Idea Shop issues with director of technology development program.

Month 3: (Recommendation: 1 dedicated team leader, 1 full-time business analyst.) Continue to fine-tune Idea collection activities and re-assess resource needs. Choose and develop best idea submitted into a presentation level concept. Resource board review of progress to date.

Month 4-6: (Recommendation: 1 full time team leader; depending on portfolio complexity and needs, 2 business analysts; consultants as needed.) Fully implement Idea Shop process. Carefully track and record timeframe for key team activities. Note and elevate issues encountered accordingly.

Month 7: (Fully implemented, although results should improve with experience.) Present concepts generated to Portfolio Manager/Resource Boards for development funding. Plan and support handoff of concept to technology development program.

A further aspect of the Idea Shop addresses the issue of patent protection. Protecting intellectual property with patents is strategically critical to an organization, both to ensure competitive advantage and to block competition from developing ideas that the organization chooses not to invest in. Patent issues are the responsibility of the Concept Team Leader. The Team Leader must identify how and when, and by whom, the patent process should be engaged to ensure patents are applied for as early as appropriate by working closely with corporate patent attorneys.

Ideas should be written up on a disclosure form and submitted to the corporate lawyer. Timely patent disclosure of ideas generated in focus groups or by the team itself will be a Concept team responsibility. Individual idea submitters, outside the Concept Team, are subject to the above issues and should be managed accordingly. The Concept Team leader will be responsible for developing and managing an appropriate idea submission patent policy for Idea Shop.

A further aspect of the Idea Shop addresses the implementation issues, including compensation and budget support. Getting quality input from the right people inside and outside an organization is critical to the success of idea generation and collection. For ideas that involve a great degree of technical knowledge, subject matter experts will give the best input. For customer needs-assessments, current sales and customer and professional services staff in addition to customers themselves will be the best sources of information. All of these people have many demands on their time. Some form of incentive will be needed to motivate participation in focus groups.

Incentives for associates of the organization can be in the form of rewards or acknowledgments. Cultural support is an important motivator. Public recognition from business units and corporate leaders is a strong incentive for many. For associates, bonuses based on participation once or twice a year may be feasible in some cases. In other cases, smaller incentives may be sufficient. Some key contributors will want more of an incentive, which may be justified depending on the significance and acceptability of the contribution. Customers may want other types of incentives including discounts on our solutions or services or some type of public recognition in exchange for participation.

The cost of focus group research includes: offsite rooms and recording equipment if needed; transcription services; incentives for participation; food/refreshments for participants.

Other incentives include: incentives/prizes for best ideas; money for patents; motivation bonuses for concept champions and concept team; program introduction and support communication costs. In general, the type of incentives should be left to the discretion of the management team. The key point is to establish the appropriate incentives that serve to continually motivate the use of the process while ensuring that the best possible flow of ideas are maintained for the health and competitiveness of the portfolio.

Implementation costs include: training costs/publicity and communication program costs; dedicated resource costs versus current costs of technology development programs and research and development costs in concept development.

A further aspect of the Idea Shop addresses organizational issues. These includes changing leadership team expectations. Currently, the leadership teams are accustomed to making concept-funding decisions based on nearly finished business plans. The Idea Shop model assumes that they will be able to make a preliminary decision without that degree of information.

Currently there are multiple points of entry into a business unit for an idea. Customer input is collected and filtered by sales and then by marketing. Advanced development (AD) and human factors engineering (HFE) generate, collect and filter ideas as well. Other ideas may come from leadership team members or from a business unit's strategic plan. One aim of Idea Shop is to centralize these diverse activities for all ideas within the scope of Idea Shop. This will be challenging depending on the current lack of alignment of the functional areas in the business unit.

The Idea Shop Process requires access to appropriate Market Research. In particular, the Idea Shop Process requires the concept team to quickly support concept ideas with market and competitive information from secondary sources. The availability of this information varies widely among Business Solution Groups.

The Idea Shop Process further requires formalized linkages with idea submission sources. Currently there is no incentive for functional organizations to participate in Idea Shop Programs. In some business units, intrafunctional communication is indirect and based upon personal relationships. Idea Shop will need top down leadership support to work within these constraints.

The Idea Shop further requires leadership buy-in. Without top level support, implementation is not feasible.

Technical Development Team. At the Concept Phase decision point, the Resource Board may assign a formal technical develop team to take the idea through the realization process. However, involving an appropriate potential technical develop team leader before the decision point may be possible with some concepts. Involving the team leader early can provide a smoother transition with the eventual technical development team and a Co-champion at the concept phase decision point. Appropriate Idea Shop practitioners, such as the Idea Owner, may also serve as consultant members of the technical development team through the next phase of the process to assure transition and continuity of the concept development is maintained. Finally, a subject matter expert who contributed to the Concept Evaluation Review may elect or be selected to become a member of the new technical development team.

To sum up the procedure for a new idea:

First, an Idea Submitter inputs/submits the idea.

The Idea Shop Process Champion and Committee chairperson are notified by e-mail of new submission.

The Committee is a cross-functional committee whose mandate is the evaluation of new technology for Retail Solution Group.

The Committee is convened monthly or when sufficient ideas have been collected.

The Committee refers promising ideas to the appropriate Business Solution Group Vice President for review.

The Business Solution Group Vice President has 5 days to accept or defer an idea and communicate its status to the Process Champion. If more than 5 days pass, the Process Champion escalates the timetable to the Business Solution Group Vice President.

The Process Champion updates status on Database. Idea Submitter is notified via e-mail.

If the Business Solution Group Vice President chooses to sponsor the idea, he or she appoints an Idea Owner to research the idea. This person could be either the financial business planner assigned to the Business Solution Group or an appropriate Product Manager depending on availability and skills needed.

Depending on Idea complexity, the idea owner has about 4 weeks to research the idea (in addition to his or her other responsibilities):

The Idea Owner identifies subject matter expert help needed to expedite concept development. The Idea Sponsor approves and arranges the use of the Subject Matter Expert (SME).

The Idea Owner Researches the idea through available secondary research, submitter and SME input in order to answer the risk questions.

The Idea Owner develops a decision point presentation (template available) of findings, presenting specific risks and showstoppers identified along with action/contingency plans to address those risks.

The Idea Owner reviews the concept with the Idea Sponsor.

If the Business Solution Group Vice President approves an Idea, the Idea Owner will then present it to the Resource Board for a concept phase Decision Point review. The Idea Sponsor may defer the presentation until several ideas are ready for presentation, assuming the market window for the ideas is not threatened.

The Resource Board will make the decision whether or not to fund subsequent developmental phases for the concept.

All supporting research, risk tool and presentation are entered into the archive database.

Since experience and intuition are a necessary component of idea and concept evaluation, choosing the right team members and providing them with the proper training and support is critical. The number of core (dedicated) and consulting members will be determined by each BU depending on the resources available to support the Idea Shop process. Logically, the number of ideas captured and the number of preliminary business cases developed per year is directly related to the number of person-hours committed by the BU.

One issue arising in connection with other initiatives in the past has been a lack of consistent implementation, dedicated resources and sustained management commitment to support previous processes. Therefore, if possible, at least one dedicated person per business unit is highly recommended to ensure process effectiveness. In order to optimize the on-going goals and requirements of Idea Shop, the process depends on consistent, on-going management and activity.

As mentioned above, the Idea Shop should be considered a long-term investment. Each business unit should pursue the goal of justifying and financing a well-qualified, well-trained dedicated team. The major benefits of a dedicated team over a non-dedicated one are:

growth and sophistication of Idea Generation programs and execution producing an on-going and dependable flow of new ideas;

consistency of team concept evaluation output and recommendations;

the ability to leverage and learn from the concept team's growing expertise; and

minimizing the costs of re-training new concept team members.

Idea creation skills are not the same as definition and development skills. Dedicating appropriate team members to idea shop activities ensures that those skills are captured and applied where they will have the most impact.

This team will continuously improve its implementation of the Idea Shop process. If dedicated, the team will provide consistency of results and cycle-time improvement as a rhythm develops. Over time, the execution effectiveness and overall quality of idea flow will evolve based on the team's experience. New members will be rotated in periodically to accommodate changing business unit goals and resource commitments, and to provide fresh perspectives. Concept team membership could be treated as a rotational product management (PM) assignment.

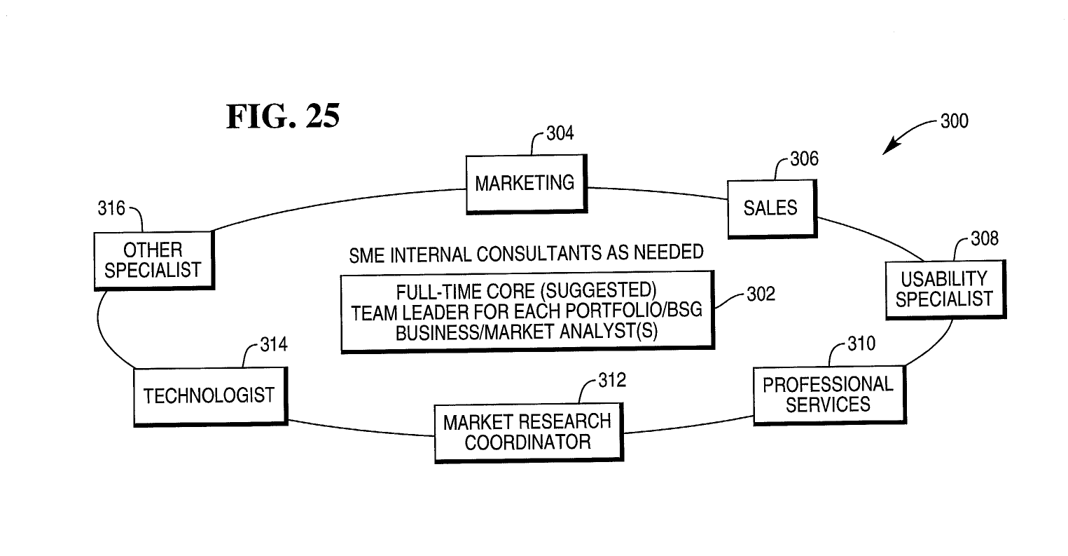

FIG. 25 is a diagram illustrating a staffing structure 300 according to a further aspect of the Idea Shop. As shown in FIG. 25, the staffing structure 300 includes a full-time core group 302. The core group 300 includes a team leader for each portfolio/BSG and a business/market analyst. The core group 302 is supported by a number of other associates and departments of the organization, including: marketing 304, sales 306, a usability specialist 308, professional services 310, a market research coordinator 312, a technologist 314, and other specialists 316. In addition, subject matter experts (SMEs) are used as internal consultants, as needed.

Both core and SME consultant Concept Team members should be:

Content with and challenged by collecting and developing many ideas to the concept decision point rather than realizing individual solutions through their respective life cycles;

Inventive, able to think out of the box and to re-frame and simplify difficult problems. Their creativity should be tempered by realistic expectations of BU and field processes.

Able to tolerate ambiguity and develop logical assumptions to fill in the blanks in the exploration new concepts for which complete information is not available.

Aware of the dangers of both knowing too much and too little.

Willing to define and justify taking sensible risks such as prototyping when needed in order to confirm concept viability.

Able to let go of unprofitable concepts in development and move on despite sunk costs incurred.

Able to recognize and plan for organizational hurdles and roadblocks. They should be able to utilize both formal and informal internal communication networks.

Able to understand and anticipate how the Idea Shop process must provide the required information in support of the development process.

Aware of the potential value of professional and customer Services and possibilities for service components in solutions.

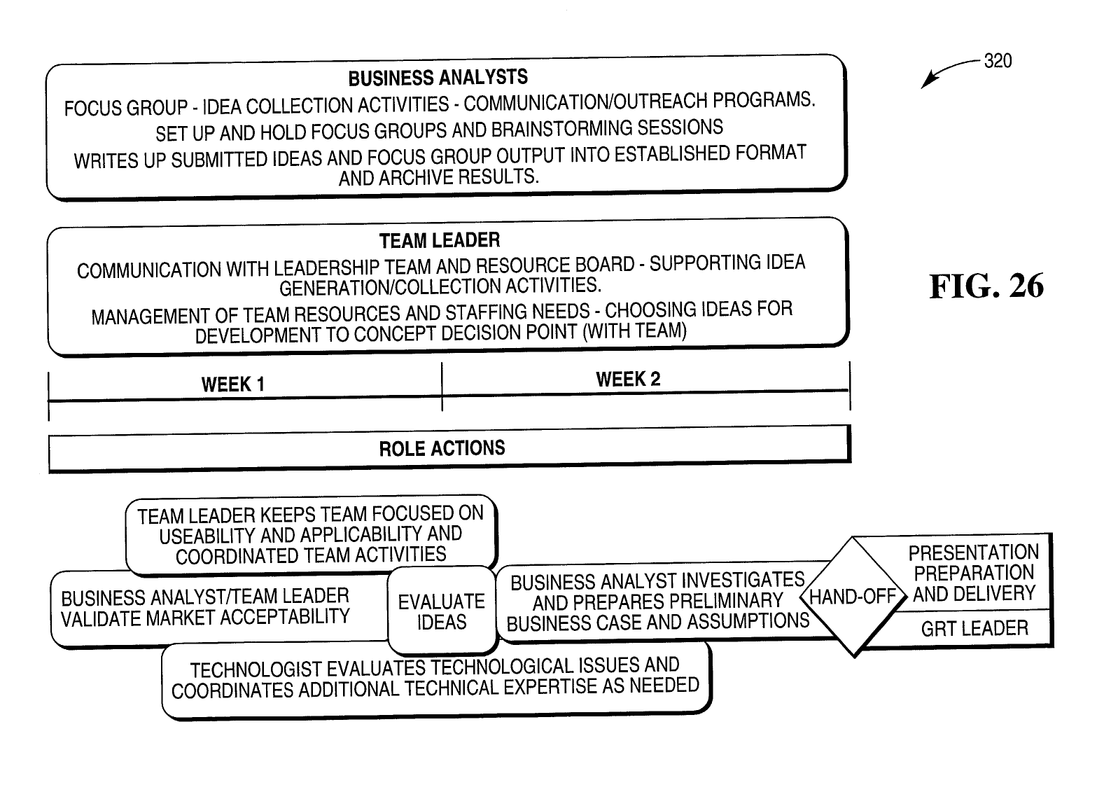

FIG. 26 is a diagram 320 illustrating the workload of the Concept Team. Regardless of size, team membership must be optimized to cover the following skills and experience:

Idea Shop Team Leader(s) (per portfolio/Business Solutions Group (BSG) if needed): The team leader must be able to lead and manage concept team activities. He or she must be responsible for outreach activities including the formation of both formal and informal relationships with functional area idea champions, region sales teams, the leadership team, resource boards and portfolio management teams, as well as major customers and quick prototyping teams.

In addition to the skills of the business analyst (below), this person should have:

Successful track record presenting/championing concepts and Preliminary Business plans to Resource Boards for concept approval and development funding.

Experience with, and understanding of, concept feasibility and potential viability of new solutions.

Familiarity with and understanding of BU and corporate strategy and portfolio goals, long and short term.

Familiarity with legal issues, concerning product development. (Non Disclosure Agreements, Invention Disclosure, Application filing process, etc.)

Business/Marketing Analyst(s): A business analyst must be able to coordinate, plan and take the responsibility for gathering the needed information to develop a “preliminary business case” for the idea. This person has very good market research/technology skills. He or she is familiar with existing research organizations throughout the BU. The candidate will act as the single point of contact with the outside market research organizations and will define research needs for considered ideas.

This person will able to:

Build a Preliminary Business Plan and write concept documents and Invention Disclosures on a fairly technical level.

Plan and hold brainstorm sessions/idea generation sessions with the different consortia, or different retailers, for future development of products and ideas from the organization.

Organize meetings with subject matter experts throughout the BU.

Prepare documentation to present to the resource board and executive documentation for the LT members.

Prepare the preliminary technical documentation for prototyping or Planning phase development team and/or potential partners and internal organization teams.

Re-evaluate original idea as additional information is discovered.

Prepare initial Project Management and Budgeting estimates. Knowledge of R&D P&L is a must, jointly with R&D Risk management. (Good financial background.)

Capture off-shoot ideas that arise while fleshing out concepts.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

I claim:

1. A method for managing the submission of ideas in an organization, comprising:
(a) collecting ideas;
(b) entering the collected ideas into an electronic archive accessible through a network;
(c) displaying the ideas to members of the organization so that the members of the organization can provide additional thoughts to the submission;
(d) providing the ideas to a management screening committee for screening; and
(e) submitting ideas screened by the management screening committee to an idea sponsor; and
(f) entering into an opportunity screening phase.

2. The method of claim 1, further including:
appointing a process champion to perform step (a).

3. The method of claim 2, wherein step (b) further includes:
providing e-mail notification of idea submissions to the process champion and to a chairperson of a management screening committee.

4. The method of claim 3, wherein step (b) further includes:
convening a meeting of the management screening committee when justified by idea submission volume.

5. The method of claim 1, wherein step (d) including performing exploratory research and development of ideas being screened by the management screening committee.

6. The method of claim 1, wherein step (a) includes:
publicizing the system to all potential submitters;
planning and holding focus groups and brainstorming sessions to stimulate targeted ideas;
generating ideas within a management screening committee by combining inputs and secondary research;
gathering information through conventions, trade shows, and customer visits;
using a knowledge management system to look for field-based development opportunities that can be leveraged into solution deliverables; and
implementing programs to collect individually submitted ideas.

7. The method of claim 1, wherein step (b) includes:
entering ideas into a web-based archive interface.

8. The method of claim 1, wherein step (c) includes:
displaying submitted ideas on an idea submission website to other potential idea submitters and to members of a management screening committee.

9. The method of claim 1, wherein in step (d), the management screening committee comprises a committee of experienced associates with varying perspectives who screen submitted ideas periodically based on volume and priority of ideas.

10. The method of claim 1, wherein in step (f) the opportunity screening phase comprises the following steps:
(f1) assigning an idea selected by the idea sponsor to an idea owner for research and for completion of process deliverables to convert the submitted idea into a concept;
(f2) contacting the idea submitter for additional input;
(f3) presenting concepts to the idea sponsor for ranking and evaluation;
(f4) presenting concepts selected by the idea sponsor to a resource board;
(f5) approving resources for concepts selected by the resource board.

11. A method for idea submission within an organization, comprising:
(a) receiving an idea submission from an Idea Submitter and entering the idea submission into a central database as an archive that is accessible by members of the organization, the archive including searchable fields and a status field indicating the status of the idea submission;
(b) appointing a process champion and a technology evaluation committee chairperson for the idea submission;
(c) notifying the process champion and the technology evaluation committee chairperson of the idea submission;
(d) convening a technology evaluation committee to evaluate the idea submission;
(e) referring the idea submission, if found to be promising by the technology evaluation committee, to an appropriate business group vice president for review and for acceptance or deferral;
(f) communicating review results to the idea shop process champion;
(g) updating the status of the idea submission in the database;
(h) notifying the idea submitter of the status of the idea submission;
(i) if the business group vice president chooses to sponsor the submitted idea, appointing an idea owner to research the idea and to convert the idea into a concept;
(j) if the business solution group vice president approves the concept, presenting the idea to a resource board for a concept phase decision point review;
(k) deciding whether or not to fund subsequent developmental phases for the idea; and
(l) entering all supporting research, evaluations and presentations into the archive.

12. A system for submitting ideas within an organization, comprising:
a network of personal computers, the network including a central network server computer having a web-based interface, an application interface, and a central idea archive database system,
each personal computer in the network being capable of displaying a display screen for receiving inputs from an idea submitter,
the central idea archive database system including an electronic archive of all submitted ideas, the archive being accessible at the personal computers in the network, the archive being searchable by keyword for enabling related ideas to be combined at a subsequent time.

13. The system of claim 12, wherein the display screen includes data input boxes for receiving inputs from an idea submitter.

14. The system of claim 13, wherein the data input boxes include an idea title box for receiving the title of an idea, an idea category box for receiving an input identifying a category for the submitted idea, a box for receiving an input identifying related current offers, solutions, or programs, a target industry box for receiving an input identifying a target industry for the submitted idea, an idea summary box for receiving a summary of the submitted idea, and a box for receiving a description of a problem solved by the submitted idea.
